(19) United States
(12) Patent Application Publication
(10) Pub. No.: US 2006/0074824 A1
(43) Pub. Date: Apr. 6, 2006

(54) Prediction by collective likelihood from emerging patterns

(76) Inventor: Jinyan Li, Singapore (SG)

Correspondence Address: CHRISTIE, PARKER & HALE, LLP, PO BOX 7068, PASADENA, CA, 91109-7068, US

(21) Appl. No.: 10/524,606

(22) PCT Filed: Aug. 22, 2002
(86) PCT No.: PCT/SG02/00190

§ 371 Date: Aug. 2, 2005

(51) Int. Cl. G06F 15/18; G06E 1/00; G06E 3/00; G06G 7/00

(52) U.S. Cl. 706/20

(57) ABSTRACT

A system, method and computer program product for determining whether a test sample is in a first or a second class of data (for example: cancerous or normal), comprising: extracting a plurality of emerging patterns from a training data set, creating a first and second list containing respectively, a frequency of occurrence of each emerging pattern that has a non-zero occurrence in the first and in the second class of data; using a fixed number of emerging patterns, calculating a first and second score derived respectively from the frequencies of emerging patterns in the first list that also occur in the test data, and from the frequencies of emerging patterns in the second list that also occur in the test data; and deducing whether the test sample is categorized in the first or the second class of data by selecting the higher of the first and the second score.

### FIELD OF THE INVENTION

The present invention generally relates to methods of data mining, and more particularly to rule-based methods of correctly classifying a test sample into one of two or more possible classes based on knowledge of data in those classes. Specifically the present invention uses the technique of emerging patterns.

### BACKGROUND OF THE INVENTION

The coming of the digital age was akin to the breaching of a dam: a torrent of information was unleashed and we are now awash in an ever-rising tide of data. Information, results, measurements and calculations—data, in general—are now in abundance and are readily accessible, in reusable form, on magnetic or optical media. As computing power continues to increase, so the promise of being able to efficiently analyze vast amounts of data is being fulfilled more often; but so also, the expectation of being able to analyze ever larger quantities is providing an impetus for developing still more sophisticated analytical schemes. Accordingly, the ever-present need to make meaningful sense of data, thereby converting it into useful knowledge, is driving substantial research efforts in methods of statistical analysis, pattern recognition and data mining. Current challenges include not only the ability to scale methods appropriately when faced with huge volumes of data, but to provide ways of coping with data that is noisy, is incomplete, or exists within a complex parameter space.

Data is more than the numbers, values or predicates of which it is comprised. Data resides in multi-dimensional spaces which harbor rich and variegated landscapes that are not only strange and convoluted, but are not readily comprehendible by the human brain. The most complicated data arises from measurements or calculations that depend on many apparently independent variables. Data sets with hundreds of variables arise today in many walks of life, including: gene expression data for uncovering the link between the genome and the various proteins for which it codes; demographic and consumer profiling data for capturing underlying sociological and economic trends; and environmental measurements for understanding phenomena such as pollution, meteorological changes and resource impact issues.

Among the principal operations that may be carried out on data, such as regression, clustering, summarization, dependency modelling, and change and deviation detection, classification is of paramount importance. Where there is no obvious correlation between particular variables, it is necessary to deduce underlying patterns and rules. Data mining classification aims to build accurate and efficient classifiers, such as patterns or rules. In the past, where this has been possible, it has been a painstaking exercise for large data sets so that, over the years, it has given rise to the field of machine learning.

Accordingly, extracting patterns, relationships and underlying rules by simple inspection has long been replaced by the use of automated analytical tools. Nevertheless, deducing patterns ideally represents not only the conquest of complexity but also the deduction of principles that indicate those parameters that are critical, and point the way to new and profitable experiments. This is the essence of useful data mining: patterns not only impose structure on the data but also provide a predictive role that can be valuable where new data is constantly being acquired. In this sense, a widely-appreciated paradigm is one in which patterns result from a “learning” process, using some initial data-set, often called a training set. However, many techniques in use today either predict properties of new data without building up rules or patterns, or build up classification schemes that are predictive but are not particularly intelligible. Furthermore, many of these methods are not very efficient for large data sets.

Recently, four desirable attributes of patterns have been articulated (see, Dong and Li, “efficient Mining of Emerging Patterns: Discovering Trends and Differences,” ACM SIGKDD International Conference on Knowledge Discovery and Data Mining, San Diego, 43-52 (August, 1999), which is incorporated herein by reference in its entirety): (a) they are valid, i.e., they are also observed in new data with high certainty; (b) they are novel, in the sense that patterns derived by machine are not obvious to experts and provide new insights; (c) they are useful, i.e., they enable reliable predictions; and (d) they are intelligible, i.e., their representation poses no obstacle to their interpretation.

In the field of machine learning, the most widely-used prediction methods include: k-nearest neighbors (see, e.g., Cover & Hart, “Nearest neighbor pattern classification,” IEEE Transactions on Information Theory, 13:21-27, (1967)); neural networks (see, e.g., Bishop, Neural Networks for Pattern Recognition, Oxford University Press (1995)); Support Vector Machines (see Burges, “A tutorial on support vector machines for pattern recognition,” Data Mining and Knowledge Discovery, 2:121-167, (1998)); Naïve Bayes (see, e.g., Langley et al., “An analysis of Bayesian classifier,” Proceedings of the Tenth National Conference on Artificial Intelligence, 223-228, (AAAI Press, 1992); originally in: Duda & Hart, Pattern Classification and Scene Analysis, (John Wiley & Sons, NY, 1973)); and C4.5 (see Quinlan, C4.5: Programs for machine learning, (Morgan Kaufmann, San Mateo, Calif., 1993)). Despite their popularity, each of these methods suffers from some drawback that means that it does not produce patterns with the four desirable attributes discussed hereinabove.

The k-nearest neighbors method (“k-NN”) is an example of an instance-based, or “lazy-learning” method. In lazy learning methods, new instances of data are classified by direct comparison with items in the training set, without ever deriving explicit patterns. The k-NN method assigns a testing sample to the class of its k nearest neighbors in the training sample, where closeness is measured in terms of some distance metric. Though the k-NN method is simple and has good performance, it often does not help fully understand complex cases in depth and never builds up a predictive rule-base.

Neural nets (see for example, Minsky & Papert, “Perceptrons: An introduction to computational geometry,” MIT Press, Cambridge, Mass., (1969)) are also examples of tools that predict the classification of new data, but without producing rules that a person can understand. Neural nets remain popular amongst people who prefer the use of “black-box” methods.

Naïve Bayes (“NB”) uses Bayesian rules to compute a probabilistic summary for each class of data in a data set. When given a testing sample, NB uses an evaluation function to rank the classes based on their probabilistic summary, and assigns the sample to the highest scoring class. However, NB only gives rise to a probability for a given instance of test data, and does not lead to generally recognizable rules or patterns. Furthermore, an important assumption used in NB is that features are statistically independent, whereas for a lot of types of data this is not the case. For example, many genes involved in a gene expression profile appear not to be independent, but some of them are closely related (see, for example, Schena et al., “Quantitative monitoring of gene expression patterns with a complementary DNA microarray”, Science, 270, 467-470, (1995); Lockhart et al., “Expression monitoring by hybridization to high-density oligonucleotide arrays”, Nature Biotech., 14:1675-1680, (1996); Velculescu et al., “Serial analysis of gene expression”, Science, 270:484-487, (1995); Chu et al., “The transcriptional program of sporulation in budding yeast”, Science, 282:699-705, (1998); DeRisi et al., “Exploring the metabolic and genetic control of gene expression on a genomic scale”, Science, 278:680-686, (1997); Roberts et al., “Signaling and circuitry of multiple MAPK pathways revealed by a matrix of global gene expression profiles”, Science, 287:873-880, (2000); Alon et al., “Broad patterns of gene expression revealed by clustering analysis of tumor and normal colon tissues probed by oligonucleotide arrays”, Proc. Natl. Acad. Sci. U.S.A., 96:6745-6750, (1999); Golub et al., “Molecular classification of cancer: Class discovery and class prediction by gene expression monitoring”, Science, 286:531-537, (1999); Perou et al., “Distinctive gene expression patterns in human mammary epithelial cells and breast cancers”, Proc. Natl. Acad. Sci. U.S.A., 96:9212-9217, (1999); Wang et al., “Monitoring gene expression profile changes in ovarian carcinomas using cdna micoroarray”, Gene, 229:101-108,(1999)).

Support Vector Machines (“SVM's”) cope with data that is not effectively modeled by linear methods. SVM's use non-linear kernel functions to construct a complicated mapping between samples and their class attributes. The resulting patterns are those that are informative because they highlight instances that define the optimal hyper-plane to separate the classes of data in multi-dimensional space. SVM's can cope with complex data, but behave like a “black box” (Furey et al., “Support vector machine classification and validation of cancer tissue samples using microarray expression data,” Bioinformatics, 16:906-914, (2000)) and tend to be computationally expensive. Additionally, it is desirable to have some appreciation of the variability of the data in order to choose appropriate non-linear kernel functions—an appreciation that will not always be forthcoming.

Accordingly, more desirable from the point of view of data mining are techniques that condense seemingly disparate pieces of information into clearly articulated rules. Two principal means of revealing structural patterns in data that are based on rules are decision trees and rule-induction. Decision trees provide a useful and intuitive framework from which to partition data sets, but are very prone to the chosen starting point. Thus, assuming that several species of rules are apparent in a training set, the rules that become immediately apparent through construction of a decision tree may depend critically upon which classifier is used to seed the tree. So it is often that significant rules, and thereby an important analytical framework for the data, are overlooked in arriving at a decision tree. Furthermore, although the translation from a tree to a set of rules is usually straightforward, those rules are not usually the clearest or simplest. By contrast, rule-induction methods are superior because they seek to elucidate as many rules as possible and classify every instance in the data set according to one or more rules. Nevertheless, a number of hybrid rule-induction, decision tree methods have been devised that attempt to capitalize respectively on the ease of use of trees and the thoroughness of rule-induction methods.

The C4.5 method is one of the most successful decision-tree methods in use today. It adapts decision tree approaches to data sets that contain continuously varying data. Whereas a straightforward rule for a leaf-node in a decision tree is simply a conjunction of all the conditions that were encountered in traversing a path through the tree from the root node to the leaf, the C4.5 method attempts to simplify these rules by pruning the tree at intermediate points and introduces error estimates for possible pruning operations. Although the C4.5 method produces rules that are easy to comprehend, it may not have good performance if the decision boundary is not linear, a phenomenon that makes it necessary to partition a particular variable differently at different points in the tree.

Recently, a class prediction method that possesses the four desirable qualities mentioned hereinabove has been proposed. It is based on the idea of emerging patterns (Dong and Li, ACM SIGKDD International Conference on Knowledge Discovery and Data Mining, San Diego, 43-52 (August, 1999)). An emerging pattern (“EP”) is useful in comparing classes of data: it indicates a property that is largely present in a first class of data, but largely absent in a second class of complementary data, i.e., data that has no overlap with the first class. Algorithms have been developed that derive EP's from large data sets and have been applied to the classification of gene expression data (see for example, Li and Wong, “Emerging Patterns and Gene Expression Data,” Genome Informatics, 12:3-13, (2001); Li and Wong, “Identifying Good Diagnostic Gene Groups from Gene Expression Profiles Using the Concept of Emerging Patterns,” Bioinformatics, 18: 725-734, (2002); and Yeoh, et al., “Classification, subtype discovery, and prediction of outcome in pediatric acute lymphoblastic leukemia by gene expression profiling,” Cancer Cell, 1:133-143, (2002), all of which are incorporated herein by reference in their entirety).

In general, it may be possible to generate many thousands of EP's from a given data set, in which case the use of EP's for classifying new instances of data can be unwieldy. Previous attempts to cope with this issue have included: Classification by Aggregating Emerging Patterns, “CAEP”, (Dong, et al., “CAEP: Classification by Aggregating Emerging Patterns,” in, DS-99: Proceedings of Second International Conference on Discovery Science, Tokyo, Japan, (Dec. 6-8, 1999); also in: Lecture Notes in Artificial Intelligence, Setsuo Arikawa, Koichi Furukawa (Eds.), 1721:3042, (Springer, 1999)); and the use of “jumping EP's” (Li, et al., “Making use of the most expressive jumping emerging patterns for classification.” Knowledge and Information Systems, 3:131-145, (2001); and, Li, et al., “The Space of Jumping Emerging Patterns and Its Incremental Maintenance Algorithms,” Proceedings of 17^{th} International Conference on Machine Learning, 552-558 (2000)), all of which are incorporated herein by reference in their entirety. In CAEP, recognizing that a given EP may only be able to classify a small number of instances in a given data set, a sample of test data is classified by constructing an aggregated score of its emerging patterns. Jumping EP's (“J-EP's”) are special EP's whose support in one class of data is zero, but whose support is non-zero in a complementary class of data. Thus J-EP's are useful in classification because they represent the patterns whose variation is strongest, but there can still be a very large number of them, meaning that analysis is still cumbersome.

The use of both CAEP and J-EP's is labor intensive because of their consideration of all, or a very large number, of EP's when classifying new data. Efficiency when tackling very large data sets is paramount in today's applications. Accordingly, a method is desired that leads to valid, novel, useful and intelligible rules, but at low cost, and by using an efficient approach for identifying the small number of rules that are truly useful in classification.

### SUMMARY OF THE INVENTION

The present invention provides a method, computer program product and system for determining whether a test sample, having test data T is categorized in one of a number of classes.

Preferably, the number n of classes is 3 or more, and the method comprises: extracting a plurality of emerging patterns from a training data set D that has at least one instance of each of the n classes of data; creating n lists, wherein: an ith list of the n lists contains a frequency of occurrence, ƒᵢ(m), of each emerging pattern EPᵢ(m) from the plurality of emerging patterns that has a non-zero occurrence in an ith class of data; using a fixed number, k, of emerging patterns, wherein k is substantially less than a total number of emerging patterns in the plurality of emerging patterns, calculate n scores wherein: an ith score of the n scores is derived from the frequencies of k emerging patterns in the ith list that also occur in the test data; and deducing which of the n classes of data the test data is categorized in, by selecting the highest of the n scores.

In particular, the present invention also provides for a method of determining whether a test sample, having test data T, is categorized in a first class or a second class, comprising: extracting a plurality of emerging patterns from a training data set D that has at least one instance of a first class of data and at least one instance of a second class of data; creating a first list and a second list wherein: the first list contains a frequency of occurrence, ƒ₁(m), of each emerging pattern EP₁(m) from the plurality of emerging patterns that has a non-zero occurrence in the first class of data; and the second list contains a frequency of occurrence, ƒ₂(m), of each emerging pattern EP₂(m) from the plurality of emerging patterns that has a non-zero occurrence in the second class of data; using a fixed number, k, of emerging patterns, wherein k is substantially less than a total number of emerging patterns in the plurality of emerging patterns, calculate: a first score derived from the frequencies of k emerging patterns in the first list that also occur in the test data, and a second score derived from the frequencies of k emerging patterns in the second list that also occur in the test data; and deducing whether the test data is categorized in the first class of data or in the second class of data by selecting the higher of the first score and the second score.

The present invention further provides a computer program product for determining whether a test sample, for which there exists test data, is categorized in a first class or a second class, wherein the computer program product is used in conjunction with a computer system, the computer program product comprising a computer readable storage medium and a computer program mechanism embedded therein, the computer program mechanism comprising: at least one statistical analysis tool; at least one sorting tool; and control instructions for: accessing a data set that has at least one instance of a first class of data and at least one instance of a second class of data; extracting a plurality of emerging patterns from the data set; creating a first list and a second list wherein, for each of the plurality of emerging patterns: the first list contains a frequency of occurrence, ƒᵢ⁽¹⁾, of each emerging pattern i from the plurality of emerging patterns that has a non-zero occurrence in the first class of data, and the second list contains a frequency of occurrence, ƒᵢ⁽²⁾, of each emerging pattern i from the plurality of emerging patterns that has a non-zero occurrence in the second class of data; using a fixed number, k, of emerging patterns, wherein k is substantially less than a total number of emerging patterns in the plurality of emerging patterns, calculate: a first score derived from the frequencies of k emerging patterns in the first list that also occur in the test data, and a second score derived from the frequencies of k emerging patterns in the second list that also occur in the test data; and deducing whether the test sample is categorized in the first class of data or in the second class of data by selecting the higher of the first score and the second score.

The present invention also provides a system for determining whether a test sample, for which there exists test data, is categorized in a first class or a second class, the system comprising: at least one memory, at least one processor and at least one user interface, all of which are connected to one another by at least one bus; wherein the at least one processor is configured to: access a data set that has at least one instance of a first class of data and at least one instance of a second class of data; extract a plurality of emerging patterns from the data set; create a first list and a second list wherein, for each of the plurality of emerging patterns: the first list contains a frequency of occurrence, ƒᵢ⁽¹⁾, of each emerging pattern i from the plurality of emerging patterns that has a non-zero occurrence in the first class of data, and the second list contains a frequency of occurrence, ƒᵢ⁽²⁾, of each emerging pattern i from the plurality of emerging patterns that has a non-zero occurrence in the second class of data; use a fixed number, k, of emerging patterns, wherein k is substantially less than a total number of emerging patterns in the plurality of emerging patterns, to calculate: a first score derived from the frequencies of k emerging patterns in the first list that also occur in the test data, and a second score derived from the frequencies of k emerging patterns in the second list that also occur in the test data; and deduce whether the test sample is categorized in the first class of data or in the second class of data by selecting the higher of the first score and the second score.

In a more specific embodiment of the method, system and computer program product of the present invention, k is from about 5 to about 50 and is preferably about 20. Furthermore, in other preferred embodiments of the present invention, only left boundary emerging patterns are used. In still other preferred embodiments, the data set comprises data selected from the group consisting of: gene expression data, patient medical records, financial transactions, census data, characteristics of an article of manufacture, characteristics of a foodstuff, characteristics of a raw material, meteorological data, environmental data, and characteristics of a population of organisms.

### BRIEF DESCRIPTION OF THE DRAWINGS

FIG. 1 shows a computer system of the present invention.

FIG. 2 shows how supports can be represented on a coordinate system.

FIG. 3 depicts a method according to the present invention for predicting a collective likelihood (PCL) of a sample T being in a first or a second class of data.

FIG. 4 depicts a representative method of obtaining emerging patterns, sorted by order of frequency in two classes of data.

FIG. 5 illustrates a method of calculating a predictive likelihood that T is in a class of data, using emerging patterns.

FIG. 6 illustrates a tree structure system for predicting more than six subtypes of Acute Lymphoblastic Leukemia (“ALL”) samples.

### DETAILED DESCRIPTION OF THE INVENTION

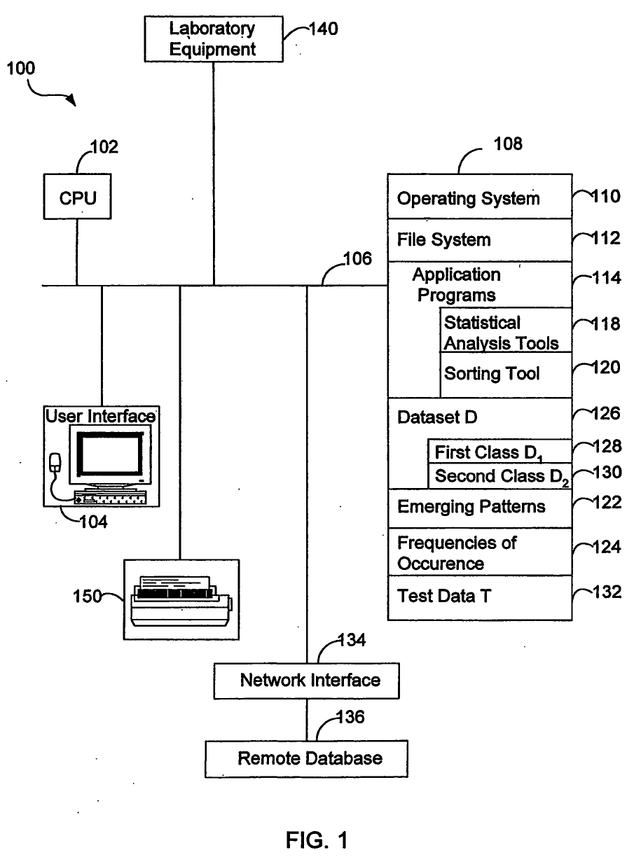

The methods of the present invention are preferably carried out on a computer system 100, as shown in FIG. 1. Computer system 100 may be a high performance machine such as a super-computer, or a desktop workstation or a personal computer, or may be a portable computer such as a laptop or notebook, or may be a distributed computing array or a cluster of networked computers.

System 100 comprises: one or more data processing units (CPU's) 102; memory 108, which will typically include both high speed random access memory as well as non-volatile memory (such as one or more magnetic disk drives); a user interface 104 which may comprise a monitor, keyboard, mouse and/or touch-screen display; a network or other communication interface 134 for communicating with other computers as well as other devices; and one or more communication busses 106 for interconnecting the CPU(s) 102 to at least the memory 108, user interface 104, and network interface 134.

System 100 may also be connected directly to laboratory equipment 140 that download data directly to memory 108. Laboratory equipment 140 may include data sampling apparatus, one or more spectrometers, apparatus for gathering micro-array data as used in gene expression analysis, scanning equipment, or portable equipment for use in the field.

System 100 may also access data stored in a remote database 136 via network interface 134. Remote database 134 may be distributed across one or more other computers, discs, file-systems or networks. Remote database 134 may be a relational database or any other form of data storage whose format is capable of handling large arrays of data, such as but not limited to spread-sheets as produced by a program such as Microsoft Excel, flat files and XML databases.

System 100 is also optionally connected to an output device 150 such as a printer, or an apparatus for writing to other media including, but not limited to, CD-R, CD-RW, flash-card, smartmedia, memorystick, floppy disk, “Zip”-disk, magnetic tape, or optical media.

The computer system's memory 108 stores procedures and data, typically including: an operating system 110 for providing basic system services; a file system 112 for cataloging and organizing files and data; one or more application programs 114, such as user level tools for statistical analysis 118 and sorting 120. Operating system 110 may be any of the following: a UNIX-based system such as Ultrix, Irix, Solaris or Aix; a Linux system; a Windows-based system such as Windows 3.1, Windows NT, Windows 95, Windows 98, Windows ME, or Windows XP or any variant thereof; or a Macintosh operating system such as MacOS 8.x, MacOS 9.x or MacOS X; or a VMS-based system; or any comparable operating system. Statistical analysis tools 118 include, but are not limited to, tools for carrying out correlation based feature selection, chi-squared analysis, entropy-based discretization, and leave-one-out cross validation. Application programs 114 also preferably include programs for data-mining and for extracting emerging patterns from data sets.

Additionally, memory 108 stores a set of emerging patterns 122, derived from a data set 126, as well as their respective frequencies of occurrence, 124. Data set 126 is preferably divided into at least a first class 128 denoted D₁, and a second class 130 denoted D₂, of data, and may have additional classes, D₁ where i>2. Data set 126 may be stored in any convenient format, including a relational database, spreadsheet, or plain text. Test data 132 may also be stored in memory 108 and may be provided directly from laboratory equipment 140, or via user interface 104, or extracted from a remote database such as 136, or may be read from an external media such as, but not limited to a floppy diskette, CD-Rom, CD-R, CD-RW or flash-card.

Data set 126 may comprise data for a limitless number and variety of sources. In preferred embodiments of the present invention, data set 126 comprises gene expression data, in which case the first class of data may correspond to data for a first type of cell, such as a normal cell, and the the second class of data may correspond to data for a second type of cell, such as a tumor cell. When data set 126 comprises gene expression data, it is also possible that the first class of data corresponds to data for a first population of subjects and the second class of data corresponds to data for a second population of subjects.

Other types of data from which data set 126 may be drawn include: patient medical records; financial transactions; census data; demographic data; characteristics of a foodstuff such as an agricultural product; characteristics of an article of manufacture, such as an automobile, a computer or an article of clothing; meteorological data representing, for example, information collected over time for one or more places, or representing information for many different places at a given time; characteristics of a population of organisms; marketing data, comprising, for example, sales and advertising figures; environmental data, such as compilations of toxic waste figures for different chemicals at different times or at different locations, global warming trends, levels of deforestation and rates of extinction of species.

Data set 126 is preferably stored in a relational database format. The methods of the present invention are not limited to relational databases, but are also applicable to data sets stored in XML, Excel spreadsheet, or any other format, so long as the data sets can be transformed into relational form via some appropriate procedures. For example, data stored in a spreadsheet has a natural row-and-column format, so that a row X and a column Y could be interpreted as a record X′ and an attribute Y′ respectively. Correspondingly, the datum in the cell at row X and column Y could be interpreted as the value V of the attribute Y′ of the record X′. Other ways of transforming data sets into relational format are also possible, depending on the interpretation that is appropriate for the specific data sets. The appropriate interpretation and corresponding procedures for format transformation would be within the capability of a person skilled in the art.

Knowledge Discovery in Databases and Data Mining

Traditionally, knowledge discovery in databases has been defined to be the non-trivial process of identifying valid, novel, potentially useful, and ultimately understandable patterns in data (see, e.g., Frawley et al., “Knowledge discovery in databases: An overview,” in Knowledge discovery in databases, 1-27, G. Piatetsky-Shapiro and W. J. Frawley, Eds., (AAAI/MIT Press, 1991)). According to the methods of the present invention, a certain type of pattern, referred to as an “emerging pattern” is of particular interest.

The process of identifying patterns generally is referred to as “data mining” and comprises the use of algorithms that, under some acceptable computational efficiency limitations, produce a particular enumeration of the required patterns. A major aspect of data mining is to discover dependencies among data, a goal that has been achieved with the use of association rules, but is also now becoming practical for other types of classifiers.

A relational database can be thought of as consisting of a collection of tables called relations; each table consists of a set of records; and each record is a list of attribute-value pairs. (see, e.g., Codd, “A relational model for large shared data bank”, Communications of the ACM, 13(6):377-387, (1970)). The most elementary term is an “attribute,“ (also called a “feature”), which is just a name for a particular property or category. A value is a particular instance that a property or category can take. For example, in transactional databases, as might be used in a business context, attributes could be the names of categories of merchandise such as milk, bread, cheese, computers, cars, books, etc.

An attribute has domain values that can be discrete (for example, categorical) or continuous. An example of a discrete attribute is color, which may take on values of red, yellow, blue, green, etc. An example of a continuous attribute is age, taking on any value in an agreed-upon range, say [0, 120]. In a transactional database, for example, attributes may be binary with values of either 0 or 1 where an attribute with a value 1 means that the particular merchandise was purchased. An attribute-value pair is called an “item,” or alternatively, a “condition.” Thus, “color-green” and “milk-1” are examples of items (or conditions).

A set of items may generally be referred to as an “itemset,” regardless of how many items are contained. A database, D, comprises a number of records. Each record consists of a number of items each of which has a cardinality equal to the number of attributes in the data. A record may be called a “transaction” or an “instance” depending on the nature of the attributes in question. In particular, the term “transaction” is typically used to refer to databases having binary attribute values, whereas the term “instance” usually refers to databases that contain multi-value attributes. Thus, a database or “data set” is a set of transactions or instances. It is not necessary for every instance in the database to have exactly the same attributes. The definition of an instance, or transaction, as a set of attribute-value pairs automatically provides for mixed instances within a single data set.

The “volume” of a database, D, is the number of instances in D, treating D as a normal set, and is denoted |D|. The “dimension” of D is the number of attributes used in D, and is sometimes referred to as the cardinality. The “count” of an itemset, X, is denoted count_{D}(X) and is defined to be the number of transactions, T, in D that contain X. A transaction containing X is written as X⊂T. The “support” of X in D, is denoted supp_{D}(X) and is the percentage of transactions in D that contain X, i.e.,

$${supp}_{D} ( X ) = \frac{{count}_{D} ( X )}{\vert D \vert} .$$

A “large”, or “frequent” itemset is one whose support is greater than some real number, δ, where 0≦δ≦1. Preferred values of δ typically depend upon the type of data being analyzed. For example, for gene expression data, preferred values of δ preferably lie between 0.5 and 0.9, wherein the latter is especially preferred. In practice, even values of δ as small as 0.001 may be appropriate, so long as the support in a counterpart or opposing class, or data set is even smaller.

An “association rule” in D is an implication of the form X→Y where X and Y are two itemsets in D, and X∩Y=0. The itemset X is the “antecedent” of the rule and the itemset Y is the “consequent” of the rule. The “support” of an association rule X→Y in D is the percentage of transactions in D that contain X∪Y. The support of the rule is thus denoted supp_{D}(X∪Y). The “confidence” of the association rule is the percentage of the transactions in D that, containing X, also contain Y. Thus, the confidence of rule X→Y is:

$$\frac{{count}_{D} ( X ⋃ Y )}{{count}_{D} ( X )} .$$

The problem of mining association rules becomes one of how to generate all association rules that have support and confidence greater than or equal to a user-specified minimum support, minsup, and minimum confidence, minconf, respectively. Generally, this problem has been solved by decomposition into two sub-problems: generate all large itemsets with respect to minsup; and, for a given large itemset generate all association rules, and output only those rules whose confidence exceeds minconf. (See, Agrawal, et al., (1993)) It turns out that the second of these sub-problems is straightforward so that the key to efficiently mining association rules is in discovering all large item-sets whose supports exceed a given threshold.

A naïve approach to discovering these large item-sets is to generate all possible itemsets in D and to check the support of each. For a database whose dimension is n, this would require checking the support of 2ⁿ−1 itemsets (i.e., not including the empty-set), a method that rapidly becomes intractable as n increases. Two algorithms have been developed that partially overcome this difficulty with the naïve method: APRIORI (Agrawal and Srikant, “Fast algorithms for mining association rules,” Proceedings of the Twentieth International Conference on Very Large Data Bases, 487-499, (Santiago, Chile, 1994)) and MAX-MINER (Bayardo, “Efficiently mining long patterns from databases,” Proceedings of the 1998 ACM-SIGMOD International Conference on Management of Data, 85-93, (ACM Press, 1998)), both of which are incorporated herein by reference in their entirety.

Despite the utility of association rules, additional classifiers are finding use in data mining applications. Informally, classification is a decision-making process based on a set of instances, by which a new instance is assigned to one of a number of possible groups. The groups are called either classes or clusters, depending on whether the classification is, respectively, “supervised” or “unsupervised.” Clustering methods are examples of unsupervised classification, in which clusters of instances are defined and determined. By contrast, in supervised classification, the class of every given instance is known at the outset and the principal objective is to gain knowledge, such as rules or patterns, from the given instances. The methods of the present invention are preferably applied to problems of supervised classification.

In supervised classification, the discovered knowledge guides the classification of a new instance into one of the pre-defined classes. Typically a classification problem comprises two phases: a “learning” phase and a “testing” phase. In supervised classification, the learning phase involves learning knowledge from a given collection of instances to produce a set of patterns or rules. A “testing” phase follows, in which the produced patterns or rules are exploited to classify new instances. A “pattern” is simply a set of conditions. Data mining classification utilizes patterns and their associated properties, such as frequencies and dependencies, in the learning phase. Two principal problems to be addressed are definition of the patterns, and the design of efficient algorithms for their discovery. However, where the number of patterns is very large—as is often the case with voluminous data sets—a third significant problem is that of how to select more effective patterns for decision-making. In addressing the third problem it is most desirable to arrive at classifiers that are not too complex and that are readily understandable by humans.

In a supervised classification problem, a “training instance” is an instance whose class label is known. For example, in a data set comprising data on a population of healthy and sick people, a training instance may be data for a person known to be healthy. By contrast, a “testing instance” is an instance whose class label is unknown. A “classifier” is a function that maps testing instances into class labels. Examples of classifiers widely used in the art are: the CBA (“Classification Based on Associations”) classifier, (Liu, et al., “Integrating classification and association rule mining,” Proceedings of the Fourth International Conference on Knowledge Discovery and Data Mining, 80-86, New York, USA, AAAI Press, (1998)); the Large Bayes (“LB”) classifier, (Meretakis and Wuthrich, Extending naïve Bayes Classifiers using long itemsets”, Proceedings of the Fifth ACM SIGKDD International Conference on Knowledge Discovery and Data Mining, 165-174, San Diego, Calif., ACM Press, (1999)); C4.5 (a decision tree based) classifier, (Quinlan, C4.5: Programs for machine learning, Morgan Kaufmann, San Mateo, Calif., (1993)); the k-NN (k-nearest neighbors) classifier, (Fix and Hodges, “Discriminatory analysis, non-parametric discrimination, consistency properties”, Technical Report 4, Project Number 21-49-004, USAF School of Aviation Medicine, Randolph Field, Tex., (1957)); perceptrons, (Rosenblatt, Principles of neurodynamics: Perceptrons and the theory of brain mechanisms, Spartan Books, Washington D.C., (1962)); neural networks, (Rosenblatt, 1962); and the NB (naïve Bayesian) classifier, (Langley, et al., “An analysis of Bayesian classifier”, Proceedings of the Tenth National Conference on Artificial Intelligence, 223-228, AAAI Press, (1992)).

The accuracy of a classifier is typically determined in one of several ways. For example, in one way, a certain percentage of the training data is withheld, the classifier is trained on the remaining data, and the classifier is then applied to the withheld data. The percentage of the withheld data correctly classified is taken as the accuracy of the classifier. In another way, a n-fold cross validation strategy is used. In this approach, the training data is partitioned into n groups. Then the first group is withheld. The classifier is trained on the other (n−1) groups and applied to the withheld group. This process is then repeated for the second group, through the n-th group. The accuracy of the classifier is taken as the averaged accuracies over that obtained for these n groups. In a third way, a leave-one-out strategy is used in which the first training instance is withheld, and the rest of the instances are used to train the classifier, which is then applied to the withheld instance. The process is then repeated on the second instance, the third instance, and so forth until the last instance is reached. The percentage of instances correctly classified in this way is taken as the accuracy of the classifier.

The present invention is involved with deriving a classifier that preferably performs well in all of the three ways of measuring accuracy described hereinabove, as well as in other ways of measuring accuracy common in the field of data mining, machine learning, and diagnostics and which would be known to one skilled in the art.

Emerging Patterns

The methods of the present invention use a kind of pattern, called an emerging pattern (“EP”), for knowledge discovery from databases. Generally speaking, emerging patterns are associated with two or more data sets or classes of data and are used to describe significant changes (for example, differences or trends) between one data set and another, or others. EP's are described in: Li, J., Mining Emerging Patters to Construct Accurate and Efficient Classifiers, Ph.D. Thesis, Department of Computer Science and Software Engineering, The University of Melbourne, Australia, (2001), which is incorporated herein by reference in its entirety. Emerging patterns are basically conjunctions of simple conditions. Preferably, emerging patterns have four qualities: validity, novelty, potential usefulness, and understandability.

The validity of a pattern relates to the applicability of the pattern to new data. Ideally a discovered EP should be valid with some degree of certainty when applied to new data. One way of investigating this property is to test the validity of an EP after the original databases have been updated by adding a small percentage of new data. An EP may be particularly strong if it remains valid even when a large percentage of new data is incorporated into the previously processed data.

Novelty relates to whether a pattern has not been previously discovered, either by traditional statistical methods or by human experts. Usually, such a pattern involves lots of conditions or a low support level, because a human expert may know some, but not all, of the conditions involved, or because human experts tend to notice those patterns that occur frequently, but not the rare ones. Some EP's, for example, consist of astonishingly long patterns comprising more than 5—including as many as 15—conditions when the number of attributes in a data set is large like 1,000, and thereby provide new and unexpected insights into previously well-understood problems.

Potential usefulness of a pattern arises if it can be used predictively. Emerging patterns can describe trends in any two or more non-overlapping temporal data sets and significant differences in any two or more spatial data sets. In this context, a “difference” refers to a set of conditions that most data of a class satisfy but none of the other class satisfies. A “trend” refers to a set of conditions that most data in a data set for one time-point satisfy, but data in a data-set for another time-point do not satisfy. Accordingly, EP's may find considerable use in applications such as predicting business market trends, identifying hidden causes to some specific diseases among different racial groups, for handwriting character recognition, for distinguishing between genes that code for ribosomal proteins and those that code for other proteins, and for differentiating positive instances and negative instances, e.g., “healthy” or “sick”, in discrete data.

A pattern is understandable if its meaning is intuitively clear from inspecting it. The fact that an EP is a conjunction of simple conditions means that it is usually easy to understand Interpretation of an EP is particularly aided when facts about its ability to distinguish between two classes of data are known.

Assuming a pair of data sets, D₁ and D₂, an EP is defined as an itemset whose support increases significantly from one data set, D₁, to another, D₂. Denoting the support of itemset X in database Dᵢ, by suppᵢ(X), the “growth rate” of itemset X from D₁ to D₂ is defined as:

$${growth\_rate}_{{D}_{1} \to {D}_{2}} ( X ) = \{ \begin{matrix}0 , & if {supp}_{1} ( X ) = 0 and {supp}_{2} ( X ) = 0 ; \\ ∞ , & if {supp}_{1} ( X ) = 0 and {supp}_{2} ( X ) \neq 0 ; \\ \frac{{supp}_{2} ( X )}{{supp}_{1} ( X )} , & otherwise .\end{matrix}$$

Thus a growth rate is the ratio of the support of itemset X in D₂ over its support in D₁. The growth rate of an EP measures the degree of change in its supports and is the primary quantity of interest in the methods of the present invention. An alternative definition of growth rate can be expressed in terms of counts of itemsets, a definition that finds particular applicability for situations where the two data sets have very unbalanced populations.

It is to be understood that the formulae presented herein are not to be limited to the case of two classes of data but, except where specifically indicated to the contrary, can be generalized by one of ordinary skill in the art to the case where the data set has 3 or more classes of data. Accordingly, it is further understood that the discussion of various methods presented herein, where exemplified by application to a situation that consists of two classes of data, can be generalized by one of skill in the art to situations where three or more classes of data are to be considered. A class of data, herein, is considered to be a subset of data in a larger dataset, and is typically selected in such a way that the subset has some property in common. For example in data taken across all persons tested in a certain way, one class may be the data on those persons or a particular sex, or who have received a particular treatment protocol.

It is more particularly preferred that EP's are itemsets whose growth rates are larger than a given threshold ρ. In particular, given ρ>1 as a growth rate threshold, an itemset X is called a ρ-emerging pattern from D₁ to D₂ if:
growth_rate_{D}_{₁}_{→D}_{₂}(X)≧ρ.
A ρ-emerging pattern is often referred to as a ρ-EP, or just an EP where a value of ρ is understood.

A ρ-EP from D₁ to D₂ where ρ=∞ is also called a “jumping EP” from D₁ to D₂. Hence a jumping EP from D₁ to D₂ is one that is present in D₂ and is absent in D₁. If D₁ and D₂ are understood, it is adequate to say jumping EP, or J-EP. The emerging patterns of the present invention are preferably J-EP's.

Given two patterns X and Y such that, for every possible instance d, X occurs in d whenever Y occurs in d, then it is said that X is more general than Y. It is also said that Y is more specific than X, if X is more general than Y.

Given a collection C of EP's from D₁ to D₂, an-EP is said to be most general in C if there is no other EP in C that is more general than it. Similarly, an EP is said to be most specific in C if there is no other EP in C that is more specific than it. There may be more than one EP that is referred to as most specific, and more than one EP that is referred to as most general, for given D₁, D₂ and C. Together, the most general and the most specific EP's in C are called the “borders” of C. The most general EP's are also called “left boundary EP's” of C. The most specific EP's are also called the right boundary EP's of C. Where the context is clear, boundary EP's are taken to mean left boundary EP's without mentioning C. The left boundary EP's are of special interest because they are most general.

Given a collection C of EP's from D₁ to D₂, a subset C′ of C is said to be a “plateau” if it includes a left boundary EP, X, of C and all the EP's in C′ have the same support in D₂ as X, and all other EP's in C but not in C′ have supports in D₂ that are different from that of X. The EP's in C′ are called “plateau EP's” of C. If C is understood, it is sufficient to say plateau EP's.

For a pair of data sets, D₁ and D₂, preferred conventions include: referring to support in D₂ as the support of an EP; referring to D₁ as the “background” data set, and D₂ as the “target” data set, wherein, e.g., the data is time-ordered; referring to D₁ as the “negative” class and D₂ as the “positive” class, wherein, e.g., the data is class-related.

Accordingly, emerging patterns capture significant changes and differences between data sets. When applied to time-stamped databases, EP's can capture emerging trends in the behavior of populations. This is because the differences between data sets at consecutive time-points in, e.g., databases that contain comparable pieces of business or demographic data at different points in time, can be used to ascertain trends. Additionally, when applied to data sets with discrete classes, EP's can capture useful contrasts between the classes. Examples of such classes include, but are not limited to: male vs. female, in data on populations of organisms; poisonous vs. edible, in populations of fungi; and cured vs. not cured, in populations of patients undergoing treatment. EP's have proven capable of building very powerful classifiers which are more accurate than, e.g., C4.5 and CBA for many data sets. EP's with low to medium support, such as 1%-20%, can give useful new insights and guidance to experts, in even “well understood” situations.

Certain special types of EP's can be found. As has been discussed elsewhere, an EP whose growth rate is so, i.e., for which support in the background data set is zero, is called a “jumping emerging pattern”, or “J-EP.” (See e.g., Li, et al., “The Space of Jumping Emerging Patterns and Its Incremental Maintenance Algorithms,” Proceedings of 17^{th} International Conference on Machine Learning, 552-558 (2000), incorporated herein by reference in its entirety.) Preferred embodiments of the present invention utilize “jumping Emerging Patterns.” Alternative embodiments use the most general EP's with high growth rate, but they are less preferred because their extraction is more complicated than that of J-EP's and because they may not necessarily give better results than J-EP's. However, in cases where no J-EP's are available (i.e., every pattern is observed in both classes), it becomes necessary to use other EP's of high growth rate.

It is common to refer to the class in which an EP has a non-zero frequency as the EP's “home” class or its own class. The other class, in which the EP has the zero, or significantly lower, frequency, is called the EP's “counterpart” class. In situations where there are more than two classes, the home class may be taken to be the class in which an EP has highest frequency.

Additionally, another special type of EP, referred to as a “strong EP”, is one that satisfies the subset-closure property that all of its non-empty subsets are also EP's. In general, a collection of sets, C, exhibits subset-closure if and only if all subsets of any set X, (X ∈ C, i.e., X is an element of C) also belong in C. An EP is called a “strong k-EP” if every subset for which the number of elements (i.e., whose cardinality) is at least k is also an EP. Although the number of strong EP's may be small, strong EP's are important because they tend to be more robust than other EP's, (i.e., they remain valid), when one or more new instances are added into training data.

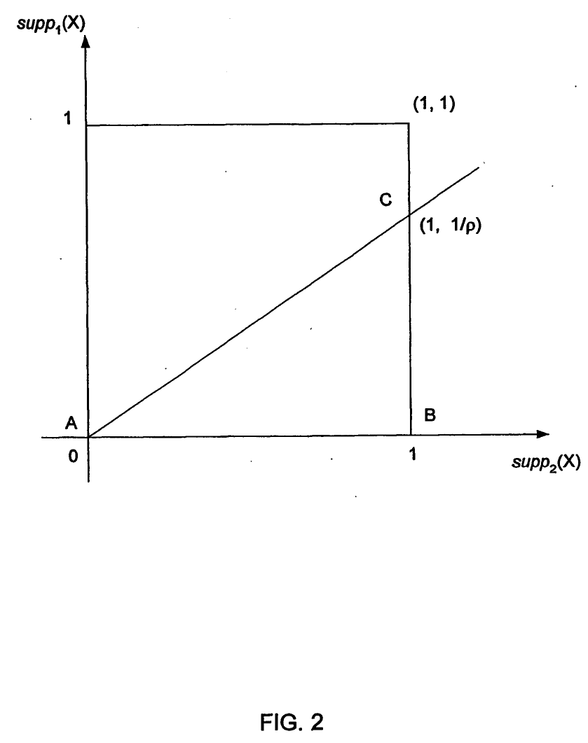

A schematic representation of EP's is shown in FIG. 1. For a growth rate threshold ρ, and two data sets, D₁ and D₂, the two supports, supp₁(X) and supp₂(X), can be represented on the y and x-axes respectively of a cartesian set. The plane of the axes is called the “support plane.” Thus, the abscissa measures the support of every item-set in the target data set, D₂. Also shown on the graph is the straight line of gradient (1/ρ) which passes through the origin, A, and intercepts the line supp₂(X)=1 at C. The point on the abscissa representing supp₂(X)=1 is denoted B. Any emerging pattern, X, from D₁ to D₂, is represented by the point (supp₁(X), supp₂(X)). If its growth rate exceeds or is equal to ρ, it must lie within, or on the perimeter of, the triangle ABC. A jumping emerging pattern lies on the horizontal axis of FIG. 2.

Boundary and Plateau Emerging Patterns

Exploring the properties of the boundary rules that separate two classes of data leads to further facets of emerging patterns. Many EP's may have very low frequency (e.g., 1 or 2) in their home class. Boundary EP's have been proposed for the purpose of capturing big differences between the two classes. A “boundary” EP is an EP, all of whose proper subsets are not EP's. Clearly, the fewer items that a pattern contains, the larger is its frequency of occurrence in a given class. Thus, removing any one item from a boundary EP increases its home class frequency. However, from the definition of a boundary EP, when this is done, its frequency in the counterpart class becomes non-zero, or increases in such a way that the EP no longer satisfies the value of the threshold ratio p. This is always true, by definition.

To see this in the case of a jumping boundary EP for example (which has non-zero frequency in the home class and zero frequency in the counterpart class), none of its subpatterns is a jumping EP. Since a subpattern is not a jumping-EP, it must have non-zero frequency in the counterpart class, otherwise, it would also be a jumping EP. In the case of a ρ-EP, the ratio of its frequency in the home class to that in the counterpart class must be greater than ρ. But removing an item from a ρ-EP makes more instances in the data in both classes satisfy it and thus the ratio p may not be satisfied any more, although in some circumstances it may be. Therefore, boundary EP's are maximally frequent in their home class because no supersets of a boundary EP can have larger frequency. Furthermore, as discussed hereinabove, sometimes, if one more item is added into an existing boundary EP, the resulting pattern may become less frequent than the original EP. So, boundary EP's have the property that they separate EP's from non-EP's. They also distinguish EP's with high occurrence from EP's with low occurrence and are therefore useful for capturing large differences between classes of data. The efficient discovery of boundary EP's has been described elsewhere (see Li et al., “The Space of Jumping Emerging Patterns and Its Incremental Maintenance Algorithms,” Proceedings of 17^{th} International Conference on Machine Learning, 552-558 (2000)).

In contrast to the foregoing example, if one more condition (item) is added to a boundary EP, thereby generating a superset of the EP, the superset EP may still have the same frequency as the boundary EP in the home class. EP's having this property are called “plateau EP's,” and are defined in the following way: given a boundary EP, all its supersets having the same frequency as itself are its “plateau EP's.” Of course, boundary EP's are trivially plateau EP's of themselves. Unless the frequency of the EP is zero, a superset EP with this property is also necessarily an EP.

Plateau EP's as a whole can be used to define a space. All plateau EP's of all boundary EP's with the same frequency as each other are called a “plateau space” (or simply, a “P-space”). So, all EP's in a P-space are at the same significance level in terms of their occurrence in both their home class and their counterpart class. Suppose that the home frequency is n, then the P-space may be denoted a “Pₙ-space.”

All P-spaces have a useful property, called “convexity,” which means that a P-space can be succinctly represented by its most general and most specific elements. The most specific elements of P-spaces contribute to the high accuracy of a classification system based on EP's. Convexity is an important property of certain types of large collections of data that can be exploited to represent such collections concisely. If a collection is a convex space, “convexity” is said to hold. By definition, a collection, C, of patterns is a “convex space” if, for any patterns X, Y, and Z, the conditions X⊂ Y⊂ Z and X, Z∈ C imply that Y∈ C. More discussion about convexity can be found in (Gunter et al., “The common order-theoretic structure of version spaces and ATMS's”, Artificial Intelligence, 95:357-407, (1997)).

A theorem on P-spaces holds as follows: given a set D_{P} of positive instances and a set D_{N} of negative instances, every Pₙ-space (n≧1) is a convex space. A proof of this theorem runs as follows: by definition, a Pₙ-space is the set of all plateau EP's of all boundary EP's with the same frequency of n in the same home class. Without loss of generality, suppose two patterns X and Z satisfy (i) X ⊂ Z; and (ii) X and Z are plateau EP's having the occurrence of n in D_{P}. Then, for any pattern Y satisfying X ⊂ Y ⊂ Z, it is a plateau EP with the same n occurrence in D_{P}. This is because:

1. X does not occur in D_{N}. So, Y, a superset of X, also does not occur in D_{N}.

2. The pattern Z has n occurrences in D_{P}. So, Y, a subset of Z, also has a non-zero frequency in D_{P}.

3. The frequency of Y in D_{P} must be less than or equal to the frequency of X, but must be larger than or equal to the frequency of Z. As the frequency of both X and Z is n, the frequency of Y in D_{P} is also n.

4. X is a superset of a boundary EP, thus Y is a superset of some boundary EP as X ⊂ Y.

From the first two points, it can be inferred that Y is an EP of D_{P}. From the third point, Y's occurrence in D_{P} is n. Therefore, with the fourth point, Y is a plateau EP. Therefore, every Pₙ-space has been proved to be a convex space.

For example, the patterns {a}, {a,b}, {a,c}, {a,d}, {a, b, c}, and {a, b, d} form a convex space. The set L consisting of the most general elements in this space is {{a}}. The set R consisting of the most specific elements in this space is {{a, b, c}, {a, b, d)}. All of the other elements can be considered to be “between” L and R. A plateau space can be bounded by two sets similar to the sets L and R. The set L consists of the boundary EP's. These EP's are the most general elements of the P-space. Usually, features contained in the patterns in R are more numerous than the patterns in L. This indicates that some feature groups can be expanded while keeping their significance.

The patterns in the central positions of a plateau space are usually even more interesting because their neighbor patterns (those patterns in the space that have one item less or more than the central pattern) are all EP's. This situation does not arise for boundary EP's because their proper subsets are not EP's. All of these ideas are particularly meaningful when the boundary EP's of a plateau space are the most frequent EP's.

Preferably, all EP's have the same infinite frequency growth-rate from their home class to their counterpart class. However, all proper subsets of a boundary EP have a finite growth-rate because they occur in both of the two classes. The manner in which these subsets change their frequency between the two classes can be ascertained by studying their growth rates.

Shadow patterns are immediate subsets of, i.e., have one item less than, a boundary EP and, as such, have special properties. The probability of the existence of a boundary EP can be roughly estimated by examining the shadow patterns of the boundary EP. Based on the idea that the shadow patterns are the immediate subsets of an EP, boundary EP's can be categorized into two types: “reasonable” and “adversely interesting.”

Shadow patterns can be used to measure the interestingness of boundary EP's. The most interesting boundary EP's can be those that have high frequencies of occurrence, but can also include those that are “reasonable” and those that are “unexpected” as discussed hereinbelow. Given a boundary EP, X, if the growth-rates of its shadow patterns approach +∞, or ρ in the case of ρ-EP's, then the existence of this boundary EP is reasonable. This is because shadow patterns are easier to recognize than the EP itself. Thus, it may be that a number of shadow patterns have been recognized, in which case it is reasonable to infer that X itself also has a high frequency of occurrence. Otherwise if the growth-rates of the shadow patterns are on average small numbers like 1 or 2, then the pattern X is “adversely interesting.” This is because when the possibility of X being a boundary EP is small, its existence is “unexpected.” In other words, it would be surprising if a number of shadow patterns had low frequencies but their counterpart boundary EP had a high frequency.

Suppose for two classes, a positive and a negative, that a boundary EP, Z, has a non-zero occurrence in the positive class. Denoting Z as {x} ∪A, where x is an item and A is a non-empty pattern, observe that A is an immediate subset of Z. By definition, the pattern A has a non-zero occurrence in both the positive and the negative classes. If the occurrence of A in the negative class is small (1 or 2, say), then the existence of Z is reasonable. Otherwise, the boundary EP Z is adversely interesting. This is because
P(x,A)=P(A)*P(x|A),
where P(pattern) is the probability of “pattern” and it is assumed that it can be approximated by the occurrence of “pattern.” If P(A) in the negative class is large, then P(x,A) in the negative class is also large. Then, the chance of the pattern {x} ∪ A=Z becoming a boundary EP is small. Therefore, if Z is indeed a boundary EP, this result is adversely interesting.

Emerging patterns have some superficial similarity to discriminant rules in the sense that both are intended to capture contrasts between different data sets. However, emerging patterns satisfy certain growth rate thresholds whereas discriminant rules do not, and emerging patterns are able to discover low-support, high growth-rate contrasts between classes, whereas discriminant rules are mainly directed towards high-support comparisons between classes.

The method of the present invention is applicable to J-EP's and other EP's which have large growth rates. For example, the method can also be applied when the input EP's are the most general EP's with growth rate exceeding 2,3,4,5, or any other numbers. However in such a situation, the algorithm for extracting EP's from the data set would be different from that used for J-EP's. For J-EP's, the preferable extraction algorithm given in: Li, et al., “The space of Jumping Emerging patterns and its incremental maintenance algorithms”, Proc. 17th International Conference on Machine Learning, 552-558, (2000), which is incorporated herein by reference in its entirety. For non-J-EPs, a more complicated algorithm is preferably used, such as is described in: Dong and Li, “efficient mining of emerging patterns: Discovering trends and differences”, Proc. 5th ACM SIGKDD International Conference on Knowledge Discovery & Data Mining, 15-18, (1999), incorporated herein by reference in its entirety.

Overview of Prediction by Collective Likelihood (PCL)

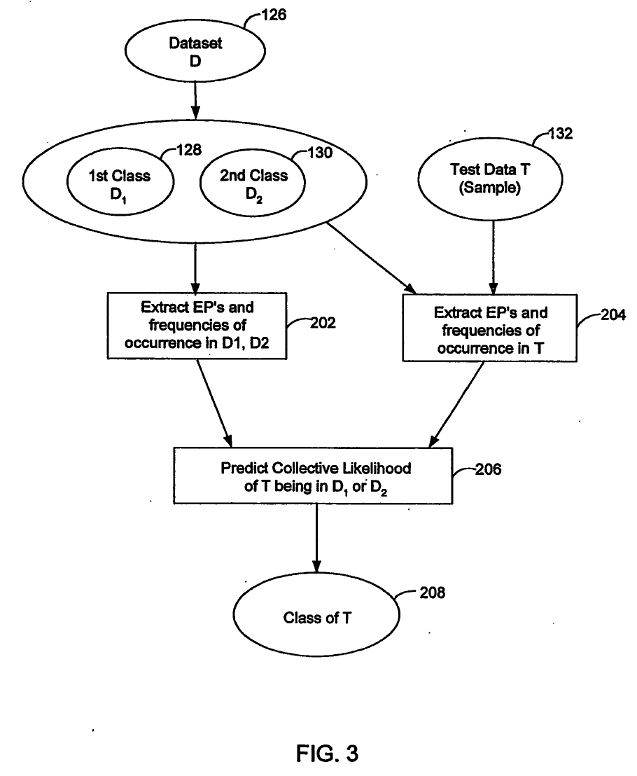

An overview of the method of the present invention, referred to as the “prediction by collective likelihood” (PCL) classification algorithm, is provided in conjunction with FIGS. 3-5. In overall approach, as shown in FIG. 3, starting with a data set 126, denoted by D, and often referred to as “training data”, or a “training set”, or as “raw data”, data set 126 is divided into a first class D₁ 128 and a second class D₂ 130. From the first class and the second class, emerging patterns and their respective frequencies of occurrence in D₁ and D₂ are determined, at step 202. Separately, emerging patterns and their respective frequencies of occurrence in test data 132, denoted by T, and also referred to as a test sample, are determined, at step 204. For determining emerging patterns and their frequencies in test data, the definitions of classes D₁ and D₂ are used. Methods of extracting emerging patterns from data sets are described in references cited herein. From the frequencies of occurrence of emerging patterns in D₁, D₂ and T, a calculation to predict the collective likelihood of T being in D₁ or D₂ is carried out at step 206. This results in a prediction 208 of the class of T, i.e., whether T should be classified in D₁ or D₂.

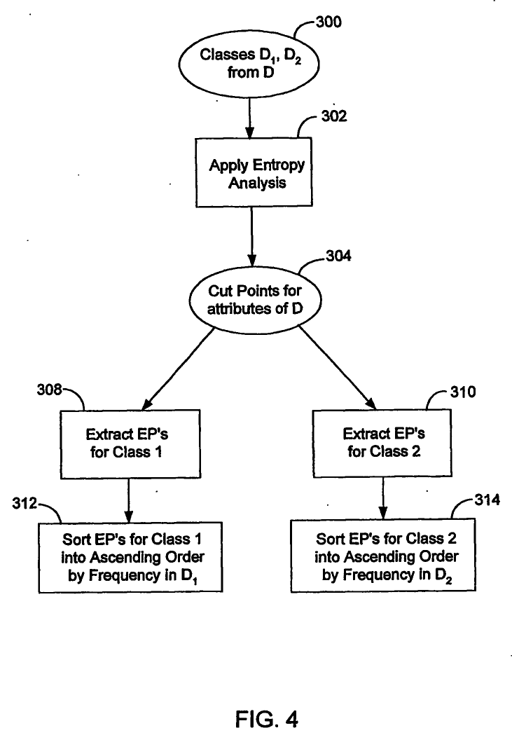

In FIG. 4, a process for obtaining emerging patterns from data set D is outlined. Starting at 300 with classes D₁ and D₂ from D, a technique such as entropy analysis is applied at step 302 to produce cut points 304 for attributes of data set D. Cut points permit identification of patterns, from which criteria for satisfying properties of emerging patterns may be used to extract emerging patterns for class 1, at step 308, and for class 2, at step 310. Emerging patterns for class 1 are preferably sorted into ascending order by frequency in D₁, at step 312, and emerging patterns for class 2 are preferably sorted into ascending order by frequency in D₂, at step 314.

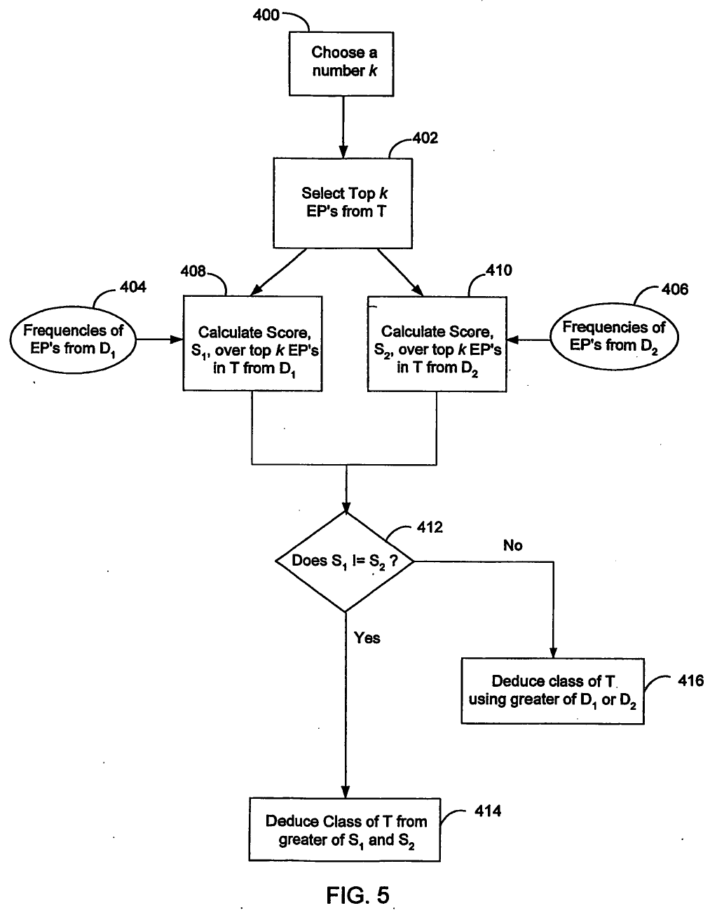

In FIG. 5, a method is described for calculating a score from frequencies of a fixed number of emerging patterns. A number, k, is chosen at step 400, and the top k emerging patterns, according to frequency in T are selected at step 402. At step 408, a score is calculated, S₁, over the top k emerging patterns in T that are also found in D₁, using the frequencies of occurrence in D₁ 404. Similarly, at step 410 a score, S₂, is calculated over the top k emerging patterns in T that are also found in D₂, using the frequencies of occurrence in D₂ 406. The values of S₁ and S₂ are compared at step 412. If the values of S₁ and S₂ are different from one another, the class of T is deduced at step 414 from the greater of S₁ and S₂. If the scores are the same, the class of T is deduced at step 416 from the greater of D₁ and D₂, 416.

Although not shown in FIGS. 3-5, it is understood that the methods of the present invention and its reduction to tangible form in a computer program product and on a system for carrying out the method, are applicable to data sets that comprise 3 or more classes of data, as described hereinbelow.

Preparation of Data

A major challenge in analyzing voluminous data is the overwhelming number of attributes or features. For example, in gene expression data, the main challenge is the huge number of genes involved. How to extract informative features and how to avoid noisy data effects are important issues in dealing with voluminous data. Preferred embodiments of the present invention use an entropy-based method (see, Fayyad, U. and Irani, K., “Multi-interval discretization of continuous-valued attributes for classification learning,” Proceedings of the 13th International Joint Conference on Artificial Intelligence, 1022-1029, (1993); and also, Kohavi, R., John, G., Long, R., Manley, D., and Pfleger, K., “MLC++: A machine learning library in C++,” Tools with Artificial Intelligence, 740-743, (1994)), and the Correlation based Feature Selection (“CFS”) algorithm (Witten, H., & Frank, E., Data mining: Practical machine learning tools and techniques with java implementation, Morgan Kaufmann, San Mateo, Calif., (2000)), to perform discretization and feature selection, respectively.

Many data mining tasks need continuous features to be discretized. The entropy-based discretization method ignores those features which contain a random distribution of values with different class labels. It finds those features which have big intervals containing almost the same class of points. The CPS method is a post-process of the discretization. Rather than scoring (and ranking) individual features, the method scores (and ranks) the worth of subsets of the discretized features.

Accordingly, in preferred embodiments of the present invention, an entropy-based discretization method is used to discretize a range of real values. The basic idea of this method is to partition a range of real values into a number of disjoint intervals such that the entropy of the intervals is minimal. The selection of the cut points in this discretization process is crucial. With the minimal entropy idea, the intervals are “maximally” and reliably discriminatory between values from one class of data and values from another class of data. This method can automatically ignore those ranges which contain relatively uniformly mixed values from both classes of data. Therefore, many noisy data and noisy patterns can be effectively eliminated, permitting exploration of the remaining discriminatory features. In order to illustrate this, consider the following three possible distributions of a range of points with two class labels, C₁ and C₂, shown in Table A:

TABLE A

| | Range 1 | Range 2 |
|---|---|---|
| (1) | All C₁ Points | All C₂ Points |
| (2) | Mixed Points | All C₂ Points |

| | |
|---|---|
| (3) | Mixed points over entire range |

For a range of real values in which every point is associated with a class label, the distribution of the labels can have three principal shapes: (1) large non-overlapping ranges, each containing the same class of points; (2) large non-overlapping ranges in which at least one contains a same class of points; (3) class points randomly mixed over the entire range. Using the middle point between the two classes, the entropy-based discretization method (Fayyad & Irani, 1993) partitions the range in the first case into two intervals. The entropy of such a partitioning is 0. That a range is partitioned into at least two intervals is called “discretization.” For the second case in Table A, the method partitions the range in such a way that the right interval contains as many C₂ points as possible and contains as few C₁ points as possible. The purpose of this is to minimize the entropies. For the third case in Table A, in which points from both classes are distributed over the entire range, the method ignores the feature, because mixed points over a range do not provide reliable rules for classification.

Entropy-based discretization is a discretization method which makes use of the entropy minimization heuristic. Of course, any range of points can trivially be partitioned into a certain number of intervals such that each of them contains the same class of points. Although the entropy of such partitions is 0, the intervals (or rules) are useless when their coverage is very small. The entropy-based method overcomes this problem by using a recursive partitioning procedure and an effective stop-partitioning criterion to make the intervals reliable and to ensure that they have sufficient coverage.

Adopting the notations presented in (Dougherty, J., Kohavi, R., & Sahami, M., “Supervised and unsupervised discretization of continuous features,” Proceedings of the Twelfth International Conference on Machine Learning, 94-202, (1995)), let T partition the set S of examples into the subsets S₁ and S₂. Let there be k classes C₁, . . . , Cₖ and let P(Cᵢ, Sⱼ) be the proportion of examples in Sⱼ that have class Cᵢ. The “class entropy” of a subset Sⱼ,j=1, 2 is defined as:

$$Ent ( {S}_{j} ) = - {\sum }_{i = 1}^{k} P ( {C}_{i} , {S}_{j} ) log ( P ( {C}_{i} , {S}_{j} ) ) .$$

Suppose the subsets S₁ and S₂ are induced by partitioning a feature A at point T. Then, the “class information entropy” of the partition, denoted E(A, T; S), is given by:

$$E ( A , T ; S ) = \frac{\vert {S}_{1} \vert}{\vert S \vert} Ent ( {S}_{1} ) + \frac{\vert {S}_{2} \vert}{\vert S \vert} Ent ( {S}_{2} ) .$$

A binary discretization for A is determined by selecting the cut point T_{A} for which E(A, T; S) is minimal amongst all the candidate cut points. The same process can be applied recursively to S₁ and S₂ until some stopping criterion is reached.

The “Minimal Description Length Principle” is preferably used to stop partitioning. According to this technique, recursive partitioning within a set of values S stops, if and only if:

$$Gain ( A , T ; S ) < \frac{{log}_{2} ( N - 1 )}{N} + \frac{δ ( A , T ; S )}{N} ,$$

where N is the number of values in the set S, Gain(A, T; S)=Ent(S)−E(A, T; S) and δ(A, T; S)=log₂(3^{k}−2)−[k Ent(S)−k₁Ent(S₁)−k₂ Ent(S₂)], wherein kᵢ is the number of class labels represented in the set Sᵢ.

This binary discretization method has been implemented by MLC++ techniques and the executable codes are available at http://www.sgi.com/tech/mlc/. It has been found that the entropy-based selection method is very effective when applied to gene expression profiles. For example, typically only 10% of the genes in a data set are selected by the technique and therefore such a selection rate provides a much easier platform from which to derive important classification rules.

Although a discretization method such as the entropy-based method is remarkable in that it can automatically remove as many as 90% of the features from a large data set, this may still mean that as many as 1,000 or so features are still present. To manually examine that many features is still tedious. Accordingly, in preferred embodiments of the present invention, the correlation based feature selection (CFS) method (Hall, Correlation-based feature selection machine learning, Ph.D. Thesis, Department of Computer Science, University of Waikato, Hamilton, New Zealand, (1998); Witten, H., & Frank, E., Data mining: Practical machine learning tools and techniques with java implementation, Morgan Kaufmann, San Mateo, Calif., (2000)) and the “Chi-Squared” (χ²) method (Lou, H., & Setiono, R., “Chi2: Feature selection and discretization of numeric attributes.” Proceedings of the IEEE 7^{th} International Conference on Tools with Artificial Intelligence, 338-391, (1995)); Witten & Frank, 2000) are used to further narrow the search for important features. Such methods are preferably employed whenever the number of remaining features after discretization is unwieldy.

In the CFS method, rather than scoring (and ranking) individual features, the method scores (and ranks) the worth of subsets of features. As the feature subset space is usually huge, CFS uses a best-first-search heuristic. This heuristic algorithm takes into account the usefulness of individual features for predicting the class, along with the level of intercorrelation among them with the belief that good feature subsets contain features highly correlated with the class, yet uncorrelated with each other. CPS first calculates a matrix of feature-class and feature-feature correlations from the training data. Then a score of a subset features assigned by the heuristic is defined as:

$${Merit}_{S} = \frac{{k}_{\overline{{r}_{cf}}}}{\sqrt{k + {k ( k - 1 )}_{\overline{{r}_{ff}}}}} ,$$

where Meritₛ is the heuristic merit of a feature subset S containing k features, \overline{r_{cf}} is the average feature-lass correlation, and \overline{r_{ff}} is the average feature-feature intercorrelation. “Symmetrical uncertainties” are used in CPS to estimate the degree of association between discrete features or between features and attributes (Hall, 1998; Witten & Frank, 2000). The symmetrical uncertainty used for two attributes or an attribute and a class X and Y, which is in the range [0,1] is given by the equation:

$${r}_{xy} = 2.0 ( \frac{H ( X ) + H ( Y ) - H ( X , Y )}{H ( X ) + H ( Y )} )$$

where H(X) is the entropy of the attribute X and is given by:

$$H ( X ) = - {\sum }_{x ∈ X} p ( x ) {log}_{2} ( p ( x ) ) .$$

CFS starts from the empty set of features and uses the best-first-search heuristic with a stopping criterion of 5 consecutive fully expanded non-improving subsets. The subset with the highest merit found during the search will be selected.

The χ² (“chi-squared”) method is another approach to feature selection. It is used to evaluate attributes (including features) individually by measuring the chi-squared (χ²) statistic with respect to the classes. For a numeric attribute, the method first requires its range to be discretized into several intervals, for example using the entropy-based discretization method described hereinabove. The χ² value of an attribute is defined as:

$${χ}^{2} = {\sum }_{i = 1}^{m} {\sum }_{j = 1}^{k} \frac{{( {A}_{ij} - {E}_{ij} )}^{2}}{{E}_{ij}} ,$$

wherein m is the number of intervals, k is the number of classes, Aᵢⱼ is the number of samples in the ith interval, jth class, and Eᵢⱼ is the expected frequency of Aᵢⱼ(i.e., Eᵢⱼ=Rᵢ*Cⱼ/N, wherein Rᵢ is the number of samples in the ith interval, Cⱼ is the number of samples in the jth class, and N is the total number of samples). After calculating the χ² value of all considered features, the values can be sorted with the largest one at the first position, because the larger the χ² value, the more important the feature is.

It is to be noted that, although the discussion of discretization and selection have been separated from one another, the discretization method also plays a role in selection because every feature that is discretized into a single interval can be ignored when carrying out the selection. Depending upon the field of study, emerging patterns can be derived using all of the features obtained by, say, the CFS method, or if these prove too numerous, using the top-selected features ranked by the χ² method. In preferred embodiments, the top 20 selected features are used. In other embodiments the top 10, 25, 30, 50 or 100 selected features, or any other convenient number between 0 and about 100, are utilized. It is also to be understood that more than 100 features may also be used, in the manners described, and where suitable.

Generating Emerging Patterns

The problem of efficiently mining strong emerging patterns from a database is somewhat similar to the problem of mining frequent itemsets, as addressed by algorithms such as APRIORI (Agrawal and Srikant, “Past algorithms for mining association rules,” Proceedings of the Twentieth International Conference on Very Large Data Bases, 487-499, (Santiago, Chile, 1994)) and MAX-MINER (Bayardo, “Efficiently mining long patterns from databases,” Proceedings of the 1998 ACM-SIGMOD International Conference on Management of Data, 85-93, (ACM Press, 1998)), both of which are incorporated by reference in their entirety. However, the efficient mining of EP's in general is a challenging problem, for two principal reasons. First, the Apriori property, which says that in order for a long pattern to occur frequently, all its subpatterns must also occur frequently, no longer holds for EP's, and second, there are usually a large number of candidate EP's for high dimensional databases or for small support thresholds such as 0.5%. Efficient methods of determining EP's which are preferably used in conjunction with the methods of the present invention, are described in: Dong and Li, “Efficient Mining of Emerging Patterns: Discovering Trends and Differences,” ACM SIGKDD International Conference on Knowledge Discovery and Data Mining, San Diego, 43-52 (August, 1999), which is incorporated herein by reference in its entirety.

To illustrate the challenges involved, consider a naïve approach to discovering EP's from data set D₁ to D₂: initially calculate the support in both D₁ and D₂ for all possible itemsets and then proceed to check whether each itemset's growth rate is larger than or equal to a given threshold. For a relation described by, say, three categorical attributes, for example, color, shape and size, wherein each attribute has two possible values, the total possible number of itemsets is 26, i.e.,

$$( \begin{matrix}3 \\ 1\end{matrix} ) * {2}^{1} + ( \begin{matrix}3 \\ 2\end{matrix} ) * {2}^{2} + ( \begin{matrix}3 \\ 3\end{matrix} ) * {2}^{3} ,$$

a sum that comprises, respectively, the number of singleton itemsets, and the number of itemsets with two and three items apiece. Of course, the number of total itemsets increases exponentially with the number of attributes so that in most cases it is very costly to conduct such an exhaustive search of all itemsets to deduce emerging patterns. An alternative naïve algorithm utilizes two steps, namely: first to discover large itemsets with respect to some support threshold in the target data set; then to enumerate those frequent itemsets and calculate their supports in the background data set, thereby identifying the EP's as those itemsets that satisfy the growth rate threshold. Nevertheless, although such a two-step approach is advantageous because it does not enumerate zero-support, and some non-zero support, itemsets in the target data set, it is often not feasible due to the exponentially increasing size of sets that belong to long frequent itemsets. In general, then, naïve algorithms are usually too costly to be effective.

To solve this problem, (a) it is preferable to promote the description of large collections of itemsets using their concise borders (the pair of sets of the minimal and of the maximal itemsets in the collections), and (b) EP mining algorithms are designed which manipulate only borders of collections (especially using the multi-border-differential algorithm), and which represent discovered EPs using borders. All EP's satisfying a constraint can be efficiently discovered by border-based algorithms, which take the borders, derived by a program such as MAX-MINER (see Bayardo, “efficiently mining long patterns from databases,” Proceedings of the 1998 ACM-SIGMOD International Conference on Management of Data, 85-93, (ACM Press, 1998)), of large itemsets as inputs.

Methods of mining EP's are accessible to one of skill in the art. Specific description of preferred methods of mining EP's, suitable for use with the present invention can be found in: “Efficient Mining of Emerging Patterns: Discovering Trends and Differences,” ACM SIGKDD International Conference on Knowledge Discovery and Data Mining, San Diego, 43-52 (August, 1999)” and “The Space of Jumping Emerging Patterns and its Incremental Maintenance Algorithms”, Proceedings of 17^{th} International Conference on Machine Learning, 552-558 (2000), both of which are incorporated herein by reference in their entirety.

Use of EP's in Classification: Prediction By Collective Likelihood (PCL)

Often, the number of boundary EP's is large. The ranking and visualization of such patterns is an important problem. According to the methods of the present invention, boundary EP's are ranked. In particular, the methods of the present invention make use of the frequencies of the top-ranked patterns for classification. The top-ranked patterns can help users understand applications better and more easily.

EP's, including boundary EP's, may be ranked in the following way.

1. Given two EP's Xᵢ and Xⱼ, if the frequency of Xᵢ is larger than that of Xⱼ, then Xᵢ is of higher priority than Xᵢ, in the list

2. When the frequency of Xᵢ is equal to the frequency of Xⱼ, if the cardinality of Xᵢ is larger than that of Xⱼ, then Xᵢ is of higher priority than Xⱼ in the list.

3. If the frequency and cardinality of Xᵢ and Xⱼ are both identical, then Xᵢ is prior to Xⱼ when Xᵢ is produced first by the method or computer system that prints or displays the EP's.

In practice, a testing sample may contain not only EP's from its own class, but also EP's from its counterpart class. This makes prediction more complicated. Preferably, a testing sample should contain many top-ranked EP's from its own class and contain a few—preferably no—low-ranked EP's from its counterpart class. However, from experience with a wide variety of data, a test sample can sometimes, though rarely, contain from about 1 to about 20 top-ranked EP's from its counterpart class. To make reliable predictions, it is reasonable to use multiple EP's that are highly frequent in the home class to avoid the confusing signals from counterpart EP's.

A preferred prediction method is as follows, exemplified for boundary EP's and a testing sample T, containing two classes of data. Consider a training data set D that has at least one instance of a first class of data and at least one instance of a second class of data, and divide D into two data sets, D₁ and D₂. Extract a plurality of boundary EP's from D₁ and D₂. The ranked n, boundary EP's of D₁ are denoted as {EP₁(i), i=1, . . . , n₁} in descending order of their frequency and are such that each has a non-zero occurrence in D₁. Similarly, the n₂ ranked boundary EP's of D₂ are denoted as: {EP₂(j), j=1, . . . n₂}, also in descending order of their frequency and are such that each has a non-zero occurrence in D₂. Both of these sets of boundary EP's may be conveniently stored in list form. The frequency of the ith EP in D₁ is denoted ƒ₁(i) and the frequency of the jth EP in D₂ is denoted ƒ₂(j). It is also to be understood that the EP's in both lists may be stored in ascending order of frequency, if desired.

Suppose that T contains the following EP's of D₁, which may be boundary EP's:
{EP₁(i₂), EP₁(i₂), . . . , EP₁(iₓ)},
where i₁<i₂< . . . <iₓ≦n₁, and x≦n₁. Suppose also that T contains the following EP's of D₂, which may be boundary EP's:
{EP₂(j₁), EP₂(j₂), . . . , EP₂(j_{y})},
where j₁<j₂< . . . ≦j_{y}≦n_{2,} and y≦n₂. In practice, it may be convenient to create a third list and a fourth list, wherein the third list may be denoted ƒ₃(m) wherein the mth item contains a frequency of occurrence, ƒᵢ(iₘ), in the first class of data of each emerging pattern iₘ from the plurality of emerging patterns that has a non-zero occurrence in D₁ and which also occurs in the test data; and wherein the fourth list may be denoted ƒ₄(m) wherein the mth item contains a frequency of occurrence, ƒ₂(jₘ), in the second class of data of each emerging pattern jₘ from the plurality of emerging patterns that has a non-zero occurrence in D₂ and which also occurs in the test data. It is thus also preferable that emerging patterns in the third list are ordered in descending order of their respective frequencies of occurrence in D₁, and similarly that the emerging patterns in said fourth list are ordered in descending order of their respective frequencies of occurrence in D₂.

The next step is to calculate two scores for predicting the class label of T, wherein each score corresponds to one of the two classes. Suppose that the k top-ranked EP's of D₁ and D₂ are used. Then the score of T in the D₁ class is defined to be:

$$score ( T ) {\_D}_{1} = {\sum }_{m = 1}^{k} \frac{{f}_{1} ( {i}_{m} )}{{f}_{1} ( m )} {\vert}_{{EP}_{1} ( {i}_{m} ) ∈ T} = {\sum }_{m = 1}^{k} \frac{{f}_{3} ( m )}{{f}_{1} ( m )} .$$

And, similarly, the score in the D₂ class is defined to be:

$$score ( T ) {\_D}_{2} = {\sum }_{m = 1}^{k} \frac{{f}_{2} ( {j}_{m} )}{{f}_{2} ( m )} {\vert}_{{EP}_{2} ( {j}_{m} ) ∈ T} = {\sum }_{m = 1}^{k} \frac{{f}_{4} ( m )}{{f}_{2} ( m )} .$$

If score(T)_D₁>score(T)_D₂, then sample T is predicted to be in the class of D. Otherwise T is predicted to be in the class D₂. If score(T)_D₁=score(T)_D₂, then the size of D₁ and D₂ is preferably used to break the tie, i.e., the Tis assigned to the larger of D₁ and D₂. Of course, the most frequently occurring EP's in T will not necessarily be the same as the top-ranked EP's in either of D₁ or D₂.

Note that score(T)_D₁>score(T)_D₂ are both sums of quotients. The value of the ith quotient can only be 1.0 if each of the top iEP's of a given class is found in T.

An especially preferred value of k is 20, though in general, k is a number that is chosen to be substantially less than the total number of emerging patterns, i.e., k is typically much less than either n, or n₂, k<<n, and k<<n₂. Other appropriate values of k are 5, 10, 15, 25, 30, 50 and 100. In general, preferred values of k lie between about 5 and about 50.

In an alternative embodiment where there are n₁, and n₂ emerging patterns of D₁ and D₂ respectively, k is chosen to be a fixed percentage of whichever of n, and n₂ is smaller. In yet another alternative embodiment, k is a fixed percentage of the total of n₁ and n₂ or of any one of n₁ and n₂. Preferred fixed percentages, in such embodiments, range from about 1% to about 5% and k is rounded to a nearest integer value in such cases where a fixed percentage does not lead to a whole number for k.

The method of calculating scores described hereinabove may be generalized to the parallel classification of multi-class data. For example, it is particularly useful for discovering lists of ranked genes and multi-gene discriminators for differentiating one subtype from all other subtypes. Such a discrimination is “global”, being one against all, in contrast to a hierarchical tree classification strategy in which the differentiation is local because the rules are expressed in terms of one subtype against the remaining subtypes below it.

Suppose that there are c classes of data, (c≦2), denoted D₁, D₂, . . . , D_{c}. First the generalized method of the present invention discovers c groups of EP's wherein the nth group (1≦n≦c) is for Dₙ versus (∪_{i≠n}Dᵢ). Feature selection and discretization may be carried out in the same way as dealing with typical two-class data. For example, the ranked EP's of Dₙ can be denoted
{EPₙ(i₁), EPₙ(i₂), . . . , EPₙ(iₓ)}
and listed in descending order of frequency.

Next, instead of a pair of scores, c scores can be calculated to predict the class label of T. That is, the score of T in the class Dₙ is defined to be:

$$score ( T ) {\_D}_{n} = {\sum }_{m = 1}^{k} \frac{{f}_{n} ( {i}_{m} )}{{f}_{n} ( m )} {\vert}_{{EP}_{0} ( {i}_{m} ) ∈ T} .$$

Correspondingly, the class with the highest score is predicted to be the class of T, and the sizes of Dₙ are used to break a tie.

An underlying principle of the method of the present invention is to measure how far away the top k EP's contained in T are from the top k EP's of a given class. By using more than one top-ranked EP's, a “collective” likelihood of more reliable predictions is utilized. Accordingly, this method is referred to as prediction by collective likelihood (“PCL”).

In the case where k=1, then score(T)_D₁ indicates whether the first-ranked EP contained in T is far from the most frequently occurring EP of D₁. In this situation, if score(T)_D₁ has its maximum value, 1, then the “distance” is very close, i.e., the most common property of D₁ is also present in the testing sample. Smaller scores indicate that the distance is greater and, thus, it becomes less likely that T belongs to the class of D₁. In general, score(T)_D₁ or score(T)_D₂ takes on its maximum value, k, if each of the k top-ranked EP's is present in T.

It is to be understood that the method of the present invention may be carried out with emerging patterns generally, including but not limited to: boundary emerging patterns; only left boundary emerging patterns; plateau emerging patterns; only the most specific plateau emerging patterns; emerging patterns whose growth rate is larger than a threshold, ρ, wherein the threshold is any number greater than 1, preferably 2 or ∞ (such as in a jumping EP) or a number from 2 to 10.

In an alternative embodiment of the present invention, plateau spaces (P-spaces, as described hereinabove) may be used for classification. In particular, the most specific elements of P-spaces are used. In PCL, the ranked boundary EP's are replaced with the most specific elements of all P-spaces in the data set and the other steps of PCL, as described hereinabove, are carried out.

The reason for the efficacy of this embodiment is that the neighborhood of the most specific elements of a P-space are all EP's in most cases, but there are many patterns in the neighborhood of boundary EP's that are not EP's. Secondly, the conditions contained in the most specific elements of a P-space are usually much more than the boundary EP's. So, the greater the number of conditions, the lower the chance for a testing sample to contain EP's from the opposite class. Therefore, the probability of being correctly classified becomes higher.

Other Methods of Using EP's in Classification

PCL is not the only method of using EP's in classification. Other methods that are as reliable and which give sound results are consistent with the aims of the present invention and are described herein.

Accordingly, for a given test instance, denoted T, and its corresponding training data D, a second method for predicting the class of T comprises the following steps wherein notation and terminology are not construed to be limiting:

1. Divide D into two sub-data sets, denoted D₁ and D₂, each consisting respectively of one of two classes of data, and create an empty list, finalEPs.

2. Discover the EP's in D₁, and similarly discover the EP's in D₂.

3. According to the frequency and the length (the number of items in a pattern), sort the EP's (from both D₁ and D₂) into a descending order. The ranking criteria are that:
(a) Given two EP's Xᵢ and Xⱼ, if the frequency of Xᵢ is larger than Xⱼ, then Xᵢ is prior to Xⱼ in the list.
(b) When the frequency of Xᵢ and Xⱼ is identical, if the length of X, is longer than Xⱼ, then Xᵢ is prior to Xⱼ in the list.
(c) The two patterns are treated equally when their frequency and length are both identical.
   The ranked EP list is denoted as orderedEPs.

4. Put the first EP of orderedEPs into finalEPs.

5. If the first EP is from D₁ (or D₂), establish a new D₁ (or a new D₂) such that it consists of those instances of D₁ (or of D₂) which do not contain the first EP.

6. Repeat from Step 2 to Step 5 until a new D₁ or a new D₂ is empty.

7. Find the first EP in the finalEPs which is contained in, or one of whose immediate proper EP subsets is contained in, T. If the EP is from the first class, the test instance is predicted to be in the first class. Otherwise the test instance is predicted to be in the second class.

According to a third method, which makes use of strong EP's to ascertain whether the system can be made more accurate, exemplary steps are as follows:

1. Divide D into two sub-data sets, denoted D₁ and D₂, consisting of the first and the second classes respectively.

2. Discover the strong EP's in D₁, and similarly discover the strong EP's in D₂.

3. According to frequency, sort each of the two lists of EP's into descending order. Denote the ordered EP lists as orderedEPs1 and orderedEPs2 respectively for the strong EP's in D₁ and D₂.

4. Find the top k EP's from orderedEPs1 such that they must be contained in T, and denote them as EP₁(1), . . . , EP₁(k). Similarly, find the top EP's from orderedEPs2 such that they must be contained in T, and denote them as EP₂(1), . . . ,EP₂(j).

5. Compare the frequency of EP₁(1) with the frequency of EP₂(1), and, if the former is larger, the test instance is predicted to be in the first class of data. Otherwise if the latter is larger, the test instance is classified in the second class of data. Tie situations are broken using strong 2-EP's, i.e., EP's whose growth rate is greater than 2.

Assessing the Usefulness of EP's in Classification

The usefulness of emerging patterns can be tested by conducting a “Leave-One-Out-Cross-Validation” (LOOCV) classification study. In LOOCV, the first instance of the data set is considered to be a test instance, and the remaining instances are treated as training data. Repeating this procedure from the first instance through to the last one, it is possible to assess the accuracy, i.e., the percent of the instances which are correctly predicted. Other methods of assessing the accuracy are known to one of ordinary skill in the art and are compatible with the methods of the present invention.

The practice of the present invention is now illustrated by means of several examples. It would be understood by one of skill in the art that these examples are not in any way limiting in the scope of the present invention and merely illustrate representative embodiments.

### EXAMPLES

### Example 1

Emerging Patterns

### Example 1.1

Biological Data

Many EP's can be found in a Mushroom Data set from the UCI repository, (Blake, C., & Murphy, P., “The UCI machine learning repository,”

http://www.cs.uci.edu/˜mlearn/MLRepository.html, also available from Department of Information and Computer Science, University of California, Irvine, USA) for a growth rate threshold of 2.5. The following are two typical EP's, each consisting of 3 items:
X={(ODOR none), (GILL_SIZE=broad), (RING_NUMBER=one)}
Y={(BRUISEs=no), (GILL_SPACING=close), (VEIL_COLOR=white)}

Their supports in two classes of mushrooms, poisonous and edible, are as follows.

| EP | supp_in_poisonous | supp_in_edible | growth_rate |
|---|---|---|---|
| X | 0% | 63.9% | ∞ |
| Y | 81.4% | 3.8% | 21.4 |

Those EP's with very large growth rates reveal notable differentiating characteristics between the classes of edible and poisonous Mushrooms, and they have been useful for building powerful classifiers (see, e.g., J. Li, G. Dong, and K. Ramamohanarao, Making use of the most expressive jumping emerging patterns for classification.” Knowledge and Information Systems, 3:131-145, (2001)). Interestingly, none of the singleton itemsets {ODOR=none}, {GILL_SIZE=broad), and {RING_NUMBER=one) is an EP, though there are some that contain more than 8 items.

### Example 1.2

Demographic Data.

About 120 collections of EP's containing up to 13 items have been discovered in the U.S. census data set, “PUMS” (available from www.census.gov). These EP's are derived by comparing the population of Texas to that of Michigan using the growth rate threshold 1.2. One such EP is:
}Disabl 1:2. Langl:2, Means:l, Mobili:2, Perscar:2, Rlabor:1, Travtim:[1.59], Work89:1}.

The items describe, respectively: disability, language at home, means of transport, personal care, employment status, travel time to work, and working or not in 1989 where the value of each attribute corresponds to an item in an enumerated list of domain values. Such EP's can describe differences of population characteristics between different social and geographic groups.

### Example 1.3

Trends in Purchasing Data

Suppose that in 1985 there were 1,000 purchases of the pattern (COMPUTER, MODEMS, EDU-SOFTWARES) out of 20 million recorded transactions, and in 1986 there were 2,100 such purchases out of 21 million transactions. This purchase pattern is an EP with a growth rate of 2 from 1985 to 1986 and thus would be identified in any analysis for which the growth rate threshold was set to a number less than 2. In this case, the support for the itemset is very small even in 1986. Thus, there is even merit in appreciating the significance of patterns that have low supports.

### Example 1.4

Medical Record Data.

Consider a study of cancer patients, where one data set contains records of patients who were cured and another contains records of patients who were not cured and where the data comprises information about symptoms, S and treatments, T. A hypothetical useful EP {S₁, S₂, T₁, T₂, T₃}, with growth rate of 9 from the not-cured to cured, may say that, among all cancer patients who had both symptoms S₁ and 52 and who had received all treatments of T₁, T₂, and T₃, the number of cured patients is 9 times the number of patients who were not cured. This may suggest that the treatment combination should be applied whenever the symptom combination occurs (if there are no better plans). The EP may have low support, such as 1% only but it may be new knowledge to the medical field because of a lack of efficient methods to find EP's with such low support and comprising so many items. This EP may even contradict the prevailing knowledge about the effect of each treatment on e.g., symptom Sᵢ. A selected set of such EP's could therefore be a useful guide to doctors in deciding what treatment should be used for a given medical situation, as indicated by a set of symptoms, for example.

### Example 1.5

Illustrative Gene Expression Data.

The process of transcribing a gene's DNA sequence into RNA is called gene expression. After translation, RNA codes for proteins that consist of amino-acid sequences. A gene expression level is the approximate number of copies of that gene's RNA produced in a cell. Gene expression data, usually obtained by highly parallel experiments using technologies like microarrays (see, e.g., Schena, M., Shalon, D., Davis, R., and Brown, P., “Quantitative monitoring of gene expression patterns with a complementary dna microarray,” Science, 270:467-470, (1995)), oligonucleotide ‘chips’ (see, e.g., Lockhart, D. J., Dong, H., Byrne, M. C., Pollettie, M. T., Gallo, M. V., Chee, M. S., Mittmann, M., Wang, C., Kobayashi, M., Horton, H., and Brown, E. L., “Expression monitoring by hybridization to high-density oligonucleotide arrays,” Nature Biotechnology, 14:1675-1680, (1996)), and Serial Analysis of Gene Expression (“SAGE”) (see, Velculescu, V., Zhang, L., Vogelstein, B., and Kinzler, K., Serial analysis of gene expression. Science, 270: 484-487, (1995)), records expression levels of genes under specific experimental conditions.

Knowledge of significant differences between two classes of data is useful in biomedicine. For example, in some gene expression experiments, medical doctors or biologists wish to know that the expression levels of certain genes or gene groups change sharply between normal cells and disease cells. Then, these genes or their protein products can be used as diagnostic indicators or drug targets of that specific disease.

Gene expression data is typically organized as a matrix. For such a matrix with n rows and m columns, n usually represents the number of considered genes, and m represents the number of experiments. There are two main types of experiments. The first type of experiments is aimed at simultaneously monitoring the n genes m times under a series of varying conditions (see, e.g., DeRisi, J. L., Iyer, V. R., and Brown, P. O., “Exploring the Metabolic and Genetic Control of Gene Expression on a Genomic Scale,” Science, 278:680-686, (1997)). This type of experiment is intended to provide any possible trends or regularities of every single gene under a series of conditions. The resulting data is generally temporal. The second type of experiment is used to examine the n genes in a single environment but from m different cells (see, e.g., Alon, U., Barkai, N., Notterman, D. A., Gish, K., Ybarra, S., Mack, D., and Levine, A. J., “Broad Patterns of Gene Expression Revealed by Clustering Analysis of Tumor and Normal Colon Tissues Probed by Oligonucleotide Arrays,” Proc. Natl. Acad. Sci. U.S.A., 96: 6745-6750, (1999)). This type of experiment is expected to assist in classifying new cells and for the identification of useful genes whose expressions are good diagnostic indicators [1, 8]. The resulting data is generally spatial.

Gene expression values are continuous. Given a gene, denoted geneⱼ, its expression values under a series of varying conditions, or under a single condition but from different types of cells, forms a range of real values. Suppose this range is [a, b] and an interval [c, d] is contained in [a, b]. Call geneⱼ@[c, d] an item, meaning that the values of geneⱼ are limited inclusively between c and d. A set of one single item, or a set of several items which come from different genes, is called a pattern. So, a pattern is of the form:
{geneᵢ₁@[aᵢ₁, bᵢ₁], . . . , geneₐ@[aᵢₖ, bᵢₖ]}

where i₁≠iₛ, 1≦k. A pattern always has a frequency in a data set This example shows how to calculate the frequency of a pattern, and, thus, emerging patterns.

TABLE B
A simple exemplary gene expression data set.

| | Cell Type | | | | | |
|---|---|---|---|---|---|---|
| Gene | normal | normal | normal | cancerous | cancerous | cancerous |
| gene_1 | 0.1 | 0.2 | 0.3 | 0.4 | 0.5 | 0.6 |
| gene_2 | 1.2 | 1.1 | 1.3 | 1.4 | 1.0 | 1.1 |
| gene_3 | −0.70 | −0.83 | −0.75 | −1.21 | −0.78 | −0.32 |
| gene_4 | 3.25 | 4.37 | 5.21 | 0.41 | 0.75 | 0.82 |

Table B consists of expression values of four genes in six cells, of which free are normal, and three are cancerous. Each of the six columns of Table B is an “instance.” The pattern {gene₁@[0.1, 0.3]}, has a frequency of 50% in the whole data set because gene₁'s expression values for the first three instances are in the interval [0.1, 0.3]. Another pattern, {gene₁@[0.1, 0.3], gene₃@[0.30, 1.21]}, has a 0% frequency in the whole data set because no single instance satisfies the two conditions: (i) that gene₁'s value must be in the range [0.1, 0.3]; and (ii) that gene₃'s value must be in the range [0.30, 1.21]. However, it can be seen that the pattern {gene₁@[0.4, 0.6]}, gene₄@[0.41, 0.82]} has a frequency of 50%.

In order to illustrate emerging patterns, the data set of Table B is divided into two sub-data sets: one consists of the values of the three normal cells, the other consists of the values of the three cancerous cells. The frequency of a given pattern can change from one sub-data set to another sub-data set. Emerging patterns are those patterns whose frequency is significantly changed between the two sub-data sets.

The pattern {gene₁@[0.1, 0.3]} is an emerging pattern because it has a frequency of 100% in the sub-data set consisting of normal cells but it has a frequency of 0% in the sub-data set of cancerous cells.

The pattern {gene₁@[0.4, 0.6], gene₄@[0.41, 0.82]} is also an emerging pattern because it has a 0% frequency in the sub-data set with normal cells.

Two publicly accessible gene expression data sets used in the subsequent examples, a leukemia data set (Golub et al., “Molecular classification of cancer: Class discovery and class prediction by gene expression monitoring”, Science, 286:531-537, (1999)) and a colon tumor data set (Alon, U., Barkai, N., Notterman, D. A., Gish, K., Ybarra, S., Mack, D., and Levine, A. J., “Broad Patterns of Gene Expression Revealed by Clustering Analysis of Tumor and Normal Colon Tissues Probed by Oligonucleotide Arrays,” Proc. Natl. Acad. Sci. U.S.A., 96:6745-6750, (1999)), are listed in Table C. A common characteristic of gene expression data is that the number of samples is small in comparison with commercial market data.

TABLE C

| Data set | Number Of Genes | Training Size | Classes |
|---|---|---|---|
| Leukemia | 7129 | 27 | ALL |
| | | 11 | AML |
| Colon | 2000 | 22 | Normal |
| | | 40 | Cancer |

In another notation, the expression level of a gene, X, can be given by gene(X). An example of an emerging pattern that changes its frequency of 0% in normal tissues to a frequency of 75% in cancer tissues taken from this colon tumor data set, contains the following three items:
{gene(K03001)≧89.20, gene(R76254)≧127.16, gene(D31767) 63.03}
where K03001, R76254 and D31767 are particular genes. According to this emerging pattern, in a new cell experiment if the gene K03001's expression value is not less than 89.20 and the gene R76254's expression is not less than 127.16 and the gene D31767's expression is not less than 63.03, then this cell would be much more likely to be a cancerous cell than a normal cell.

### Example 2

Emerging Patterns from a Tumor Data Set.

This data set contains gene expression levels of normal cells and cancer cells and is obtained by one of the second type of experiments discussed in Example 1.4. The data consists of gene expression values for about 6,500 genes of 22 normal tissue samples and 40,colon tumor tissue samples obtained from an Affymetrix Hum6000 array (see, Alon et al., “Broad patterns of gene expression revealed by clustering analysis of tumor and normal colon tissues probed by oligonucleotide arrays,” Proceedings of National Academy of Sciences of the United States of American, 96:6745-6750, (1999)). The expression level of 2,000 genes of these samples were chosen according to their minimal intensity across the samples, those genes with lower minimal intensity were ignored. The reduced data set is publicly available at the internet site http://microarray.princeton.edu/oncology/affydata/index.html.

This example is primarily concerned with the following problems:

1. Which intervals of the expression values of a gene, or which combinations of intervals of multiple genes, only occur in the cancer tissues but not in the normal tissues, or only occur in the normal tissues but not in the cancer tissues?

2. How is it possible to discretize a range of the expression values of a gene into multiple intervals so that the above mentioned contrasting intervals or interval combinations, in all EP's, are informative and reliable?

3. Can the discovered patterns be used to perform classification tasks, i.e., predicting whether a new cell is normal or cancerous, after conducting the same type of expression experiment?

These problems are solved using several techniques. For the colon cancer data set, of its 2,000 genes, only 35 relevant genes are discretized into 2 intervals while the remaining 1,965 genes are ignored by the method. This result is very important since most of the genes have been viewed as “trivial” ones, resulting in an easy platform where a small number of good diagnostic indicators are concentrated.

For discretization, the data was re-organized in accordance with the format required by the utilities of MLC++ (see, Kohavi, R., John, G., Long, R., Manley, D., and Pfleger, K., “MLC++: A machine learning library in C++,” Tools with Artificial Intelligence, 740-743, (1994)). In short, the re-organized data set is diagonally symmetrical to the original data set. In this example, we present the discretization results to see which genes are selected and which genes are discarded. An entropy-based discretization method generates intervals that are “maximally” and reliably discriminatory between expression values from normal cells and expression values from cancerous cells. The entropy-based discretization method can thus automatically ignore most of the genes and select a few most discriminatory genes.

The discretization method partitions 35 of the 2,000 genes each into two disjoint intervals, while there is no cut point in the remaining 1,965 genes. This indicates that only 1.75% (=35/2000) of the genes are considered to be particularly discriminatory genes and that the others can be considered to be relatively unimportant for classification. Deriving a small number of good diagnostic genes, the discretization method thus lays down a foundation for the efficient discovery of reliable emerging patterns, thereby obviating the generation of huge numbers of noisy patterns.

The discretization results are summarized in Table D, in which: the first column contains the list of 35 genes; the second column shows the gene numbers; the intervals are presented in column 3; and the gene's sequence and name are presented at columns 4 and 5, respectively. The intervals in Table D are expressed in a well-known mathematical convention in which a square bracket means inclusive of the boundary number of the range and a round bracket excludes the boundary number.

TABLE D
The 35 genes which were discretized by the entropy-based method into more than one interval.

| List | Gene | | | |
|---|---|---|---|---|
| number | number | Intervals | Sequence | Name |
| 1 | T51560 | (−∞, 101.3719), [101.3719, +∞) | 3′ UTR | 40S RIBOSOMAL PROTEIN S16 (HUMAN) |
| 2 | T49941 | (−∞, 272.5444), [272.5444, +∞) | 3′ UTR | PUTATIVE INSULIN-LIKE GROWTH |
| | | | | FACTOR II ASSOCIATED (HUMAN) |
| 3 | M62994 | (−∞, 94.39874), [94.39874, +∞) | gene | Homo sapiens thyroid autoantigen (truncated |
| | | | | actin-binding protein) mRNA, complete cds |
| 4 | R34701 | (−∞, 446.0319), [446.0319, +∞) | 3′ UTR | TRANS-ACTING TRANSCRIPTIONAL |
| | | | | PROTEIN ICP4 (Varicella-zoster virus) |
| 5 | X62153 | (−∞, 395.2505), [395.2505, +∞) | gene | H. sapiens mRNA for P1 protein (P1.h) |
| 6 | T72403 | (−∞, 296.5696), [296.5696, +∞) | 3′ UTR | HLA CLASS II HISTOCOMPATIBILITY |
| | | | | ANTIGEN, DQ(3) ALPHA CHAIN |
| | | | | PRECURSOR (Homo sapiens) |
| 7 | L02426 | (−∞, 390.6063), [390.6063, +∞) | gene | Human 26S protease (S4) regulatory subunit |
| | | | | mRNA, complete cds |
| 8 | K03001 | (−∞, 89.19624), [89.19624, +∞) | gene | Human aldehyde dehydrogenase 2 mRNA |
| 9 | U20428 | (−∞, 207.8004), [207.8004, +∞) | gene | Human unknown protein (SNC19) mRNA, |
| | | | | partial cds |
| 10 | R53936 | (−∞, 206.2879), [206.2879, +∞) | 3′ UTR | PROTEIN PHOSPHATASE 2C HOMOLOG 2 |
| | | | | (Schizosaccharomyces pombe) |
| 11 | H11650 | (−∞, 211.6081), [211.6081, +∞) | 3′ UTR | ADP-RIBOSYLATION FACTOR 4 (Homo |
| | | | | sapiens) |
| 12 | R59097 | (−∞, 402.66), [402.66, +∞) | 3′ UTR | TYROSINE-PROTEIN KINASE RECEPTOR |
| | | | | TIE-1 PRECURSOR (Mus musculus) |
| 13 | T49732 | (−∞, 119.7312), [119.7312, +∞) | 3′ UTR | Human SnRNP core protein Sm D2 mRNA, |
| | | | | complete cds |
| 14 | J04182 | (−∞, 159.04), [159.04, +∞) | gene | LYSOSOME-ASSOCIATED MEMBRANE |
| | | | | GLYCOPROTEIN 1 PRECURSOR (HUMAN) |
| 15 | M33680 | (−∞, 352.3133), [352.3133, +∞) | gene | Human 26-kDa cell surface protein TAPA-1 |
| | | | | mRNA, complete cds |
| 16 | R09400 | (−∞, 219.7038), [219.7038, +∞) | 3′ UTR | S39423 PROTEIN I-5111, |
| | | | | INTERFERON-GAMMA-INDUCED |
| 17 | R10707 | (−∞, 378.7988), [378.7988, +∞) | 3′ UTR | TRANSLATIONAL INITIATION FACTOR 2 |
| | | | | ALPHA SUBUNIT (Homo sapiens) |
| 18 | D23672 | (−∞, 466.8373), [466.8373, +∞) | gene | Human mRNA for biotin-[propionyl-CoA- |
| | | | | carboxylase (ATP-hydrolysing)] ligase, |
| | | | | complete cds |
| 19 | R54818 | (−∞, 153.1559), [153.1559, +∞) | 3′ UTR | Human eukaryotic initiation factor 2B-epsilon |
| | | | | mRNA, partial cds |
| 20 | J03075 | (−∞, 218.1981), [218.1981, +∞) | gene | PROTEIN KINASE C SUBSTRATE, 80 KD |
| | | | | PROTEIN, HEAVY CHAIN (HUMAN); |
| | | | | contains TAR1 repetitive element |
| 21 | T51250 | (−∞, 212.137), [212.137, +∞) | 3′ UTR | CYTOCHROME C OXIDASE |
| | | | | POLYPEPTIDE VIII-LIVER/HEART |
| | | | | (HUMAN) |
| 22 | X12671 | (−∞, 149.4719), [149.4719, +∞) | gene | Human gene for heterogeneous nuclear |
| | | | | ribonucleoprotein (hnRNP) core protein A1 |
| 23 | T49703 | (−∞, 342.1025), [342.1025, +∞) | 3′ UTR | 60S ACIDIC RIBOSOMAL PROTEIN P1 |
| | | | | (Polyorchis penicillatus) |
| 24 | U03865 | (−∞, 76.86501), [76.86501, +∞) | gene | Human adrenergic alpha-1b receptor protein |
| | | | | mRNA, complete cds |
| 25 | X16316 | (−∞, 65.27499), [65.27499, +∞) | gene | VAV ONCOGENE (HUMAN) |
| 26 | U29171 | (−∞, 181.9562), [181.9562, +∞) | gene | Human casein kinase I delta mRNA, complete |
| | | | | cds |
| 27 | H89983 | (−∞, 200.727), [200.727, +∞) | 3′ UTR | METALLOPAN-STIMULIN 1 (Homo sapiens) |
| 28 | T52003 | (−∞, 180.0342), [180.0342, +∞) | 3′ UTR | CCAAT/ENHANCER BINDING PROTEIN |
| | | | | ALPHA (Rattus norvegicus) |
| 29 | R76254 | (−∞, 127.1584), [127.1584, +∞) | 3′ UTR | ELONGATION FACTOR 1-GAMMA (Homo |
| | | | | sapiens) |
| 30 | M95627 | (−∞, 65.27499), [65.27499, +∞) | gene | Homo sapiens angio-associated migratory cell |
| | | | | protein (AAMP) mRNA, complete cds |
| 31 | D31767 | (−∞, 63.03381), [63.03381, +∞) | gene | Human mRNA (KIAA0058) for ORF (novel |
| | | | | protein), complete cds |
| 32 | R43914 | (−∞, 65.27499), [65.27499, +∞) | 3′ UTR | CREB-BINDING PROTEIN (Mus musculus) |
| 33 | M37721 | (−∞, 963.0405), [963.0405, +∞) | gene | PEPTIDYL-GLYCINE ALPHA-AMIDATING |
| | | | | MONOOXYGENASE PRECURSOR |
| | | | | (HUMAN); contains Alu repetitive element |
| 34 | L40992 | (−∞, 64.85062), [64.85062, +∞) | gene | Homo sapiens (clone PEBP2aA1) core-binding |
| | | | | factor, runt domain, alpha subunit 1 (CBFA1) |
| | | | | mRNA, 3′ end of cds |
| 35 | H15662 | (−∞, 894.9052), [894.9052, +∞) | 3′ UTR | GLUTAMATE (Mus musculus) |

There is a total of 70 intervals. Accordingly, there are 70 items involved, where an item is a pair comprising a gene linked with an interval. The 70 items are indexed, as follows: the first gene's two intervals are indexed as the 1^{st and} 2^{nd items, the ith gene's two intervals as the (i*}2−1)th and (i*2)th items, and the 35 gene's two intervals as the 69^{th} and 70^{th} items. This index is convenient when reading and writing emerging patterns. For example, the pattern {2} represents {gene_{T51560}@[101.3719, +∞)}.

Emerging patterns based on the discretized data were discovered using two efficient border-based algorithms, BORDER-DIFF and JEP-PRODUCER (see, Dong, G. and Li, J., “Efficient mining of emerging patterns: Discovering trends and differences,” Proceedings of the Fifth ACM SIGKDD International Conference on Knowledge Discovery and Data Mining, 43-52, (1999); Li, J., Mining Emerging Patterns to Construct Accurate and Efficient Classifiers, Ph.D. Thesis, Department of Computer Science and Software Engineering, University of Melbourne, Australia; Li, J., Dong, G., and Ramamohanarao, K., “Making use of the most expressive jumping emerging patterns for classification,” Knowledge and Information Systems, 3:131-145, (2001); and Li, J., Ramamohanarao, K., and Dong, G., “The space of jumping emerging patterns and its incremental maintenance algorithms,” Proceedings of the Seventeenth International Conference on Machine Learning, 551-558, (2000)). The algorithms can derive “Jumping Emerging Patterns”—those EP's which are maximally frequent in one class of data (i.e., in this case normal tissues or cancerous tissues), but do not occur at all in the other class. A total of 19,501 EP's, which have a non-zero frequency in the normal tissues of the colon tumor data set, were discovered, and a total of 2,165 EP's which have a non-zero frequency in the cancerous tissues, were derived by these algorithms.

Tables E and F list, sorted by descending order of frequency of occurrence, for the 22 normal tissues and the 40 cancerous tissues respectively, the top 20 EP's and strong EP's. In each case, column 1 shows the EP's. The numbers in the patterns, for example 16, 58, and 62 in the pattern { 16, 58, 62}, stand for the items discussed and indexed hereinabove.

TABLE E
The top 20 EP's and the top 20 strong EP's in the 22 normal tissues.

| | | Freq. in | Freq. in | | | Freq. in |
|---|---|---|---|---|---|---|
| Emerging Patterns | Counts | normal tissues | tumor tissues | Strong EP's | Counts | normal tissues |
| {2, 3, 6, 7, 13, 17, 33} | 20 | 90.91% | 0% | {67} | 7 | 31.82% |
| {2, 3, 11, 17, 23, 35} | 20 | 90.91% | 0% | {59} | 6 | 27.27% |
| {2, 3, 11, 17, 33, 35} | 20 | 90.91% | 0% | {61} | 6 | 27.27% |
| {2, 3, 7, 11, 17, 33} | 20 | 90.91% | 0% | {70} | 6 | 27.27% |
| {2, 3, 7, 11, 17, 23} | 20 | 90.91% | 0% | {49} | 6 | 27.27% |
| {2, 3, 6, 7, 13, 17, 23} | 20 | 90.91% | 0% | {66} | 6 | 27.27% |
| {2, 3, 6, 7, 9, 17, 33} | 20 | 90.91% | 0% | {63} | 6 | 27.27% |
| {2, 3, 6, 7, 9, 17, 23} | 20 | 90.91% | 0% | {49, 66} | 4 | 18.18% |
| {2, 3, 6, 17, 23, 35} | 20 | 90.91% | 0% | {49, 66} | 4 | 18.18% |
| {2, 3, 6, 17, 33, 35} | 20 | 90.91% | 0% | {59, 63} | 4 | 18.18% |
| {2, 6, 7, 13, 39, 41} | 19 | 86.36% | 0% | {59, 70} | 4 | 18.18% |
| {2, 3, 6, 7, 13, 41} | 19 | 86.36% | 0% | {59, 63} | 4 | 18.18% |
| {2, 6, 35, 39, 41, 45} | 19 | 86.36% | 0% | {59, 70} | 4 | 18.18% |
| {2, 3, 6, 7, 9, 31, 33} | 19 | 86.36% | 0% | {49, 59, 66} | 3 | 13.64% |
| {2, 6, 7, 39, 41, 45} | 19 | 86.36% | 0% | {49, 59, 66} | 3 | 13.64% |
| {2, 3, 6, 7, 41, 45} | 19 | 86.36% | 0% | {59, 61, 63} | 3 | 13.64% |
| {2, 6, 9, 35, 39, 41} | 19 | 86.36% | 0% | {59, 63, 70} | 3 | 13.64% |
| {2, 3, 17, 21, 23, 35} | 19 | 86.36% | 0% | {59, 61, 63} | 3 | 13.64% |
| {2, 3, 6, 7, 11, 23, 31} | 19 | 86.36% | 0% | {59, 63, 70} | 3 | 13.64% |
| {2, 3, 6, 7, 13, 23, 31} | 19 | 86.36% | 0% | {49, 59, 66} | 3 | 13.64% |

TABLE F
The top 20 EP's and the top 20 strong EP's in the 40 cancerous tissues.

| | | Freq. | Freq. in | | | Freq. In |
|---|---|---|---|---|---|---|
| Emerging Patterns | Counts | normal tissues | tumor tissues | Strong EP's | Counts | normal tissues. |
| {16, 58, 62} | 30 | 0% | 75.00% | {30} | 18 | 45.00% |
| {26, 58, 62} | 26 | 0% | 65.00% | {14} | 16 | 40.00% |
| {28, 58} | 25 | 0% | 62.50% | {10} | 15 | 37.50% |
| {26, 52, 62, 64} | 25 | 0% | 62.50% | {24} | 15 | 37.50% |
| {26, 52, 68} | 25 | 0% | 62.50% | {34} | 14 | 35.00% |
| {16, 38, 58} | 24 | 0% | 60.00% | {36} | 13 | 32.50% |
| {16, 42, 62} | 24 | 0% | 60.00% | {1} | 13 | 32.50% |
| {16, 26, 52, 62} | 24 | 0% | 60.00% | {5} | 13 | 32.50% |
| {16, 42, 68} | 24 | 0% | 60.00% | {8} | 13 | 32.50% |
| {26, 28, 52} | 23 | 0% | 57.50% | {24, 30} | 11 | 27.50% |
| {16, 38, 52, 68} | 23 | 0% | 57.50% | {30, 34} | 11 | 27.50% |
| {16, 38, 52, 62} | 23 | 0% | 57.50% | {24, 30} | 11 | 27.50% |
| {26, 52, 54} | 22 | 0% | 55.00% | {30, 34} | 11 | 27.50% |
| {26, 32} | 22 | 0% | 55.00% | {10, 14} | 10 | 25.00% |
| {16, 54, 58} | 22 | 0% | 55.00% | {10, 14} | 10 | 25.00% |
| {16, 56, 58} | 22 | 0% | 55.00% | {24, 34} | 9 | 22.50% |
| {26, 38, 58} | 22 | 0% | 55.00% | {14, 24} | 9 | 22.50% |
| {32, 58} | 22 | 0% | 55.00% | {8, 10} | 9 | 22.50% |
| {16, 52, 58} | 22 | 0% | 55.00% | {10, 24} | 9 | 22.50% |
| {22, 26, 62} | 22 | 0% | 55.00% | {8, 10} | 9 | 22.50% |

Some principal insights that can be deduced from the emerging patterns are summarized as follows. First, the border-based algorithm is guaranteed to discover all the emerging patterns.

Some of the emerging patterns are surprisingly interesting, particularly for those that contain a relatively large number of genes. For example, although the pattern {2, 3, 6, 7, 13, 17, 33} combines 7 genes together, it can still have a very large frequency (90.91%) in the normal tissues, namely almost every normal cell's expression values satisfy all of the conditions implied by the 7 items. However, no single cancerous cell satisfies all the conditions. Observe that all of the proper sub-patterns of the pattern {2, 3, 6, 7, 13, 17, 33}, including singletons and the combinations of six items, must have a non-zero frequency in both of the normal and cancerous tissues. This means that there must exist at least one cell from both of the normal and cancerous tissues satisfying the conditions implied by any sub-patterns of {2, 3, 6, 7, 13, 17, 33}.

The frequency of a singleton emerging pattern such as {5} is not necessarily larger than the frequency of an emerging pattern that contains more than one item, for example {16, 58, 62}. Thus the pattern {5} is an emerging pattern in the cancerous tissues with a frequency of 32.5% which is about 2.3 times less than the frequency (75%) of the pattern {16, 58, 62}. This indicates that, for the analysis of gene expression data, groups of genes and their correlations are better and more important than single genes.

Without the discretization method and the border-based EP discovery algorithms, it is very hard to discover those reliable emerging patterns that have large frequencies. Assuming that the 1,965 other genes are each partitioned into two intervals as well, then there are ⁷C₂₀₀₀*2⁷ possible patterns having a length of 7. The enumeration of such a huge number of patterns and the calculation of their frequencies is practically impossible at this time. Even with the discretization method, the naïve enumeration of ⁷C₃₅*2⁷ patterns is still too expensive for discovering the pattern (2, 3, 6, 7, 13, 17, 33). It can be appreciated that the problem is even more complex in reality, when it is acknowledged that some of the discovered EP's (not listed here) contain more than 7 genes.

Through the use of the two border-based algorithms, only those EP's whose proper subsets are not emerging patterns, are discovered. Interestingly, other EP's can be derived using the discovered EP's. Generally, any proper superset of a discovered EP is also an emerging pattern. For example, using the EP's with the count of 20 (shown in Table E), a very long emerging pattern, {2, 3, 6, 7, 9, 11, 13, 17, 23, 29, 33, 35}, that consists of 12 genes, with the same count of 20 can be derived.

Note that any of the 62 tissues must match at least one emerging pattern from its own class, but never contain any EP's from the other class. Accordingly, the system has learned the whole data well because every item of data is covered by a pattern discovered by the system.

In summary, the discovered emerging patterns always contains a small number of genes. This result not only allows users to focus on a small number of good diagnostic indicators, but more importantly it reveals some interactions of the genes which are originated in the combination of the genes' intervals and the frequency of the combinations. The discovered emerging patterns can be used to predict the properties of a new cell.

Next, emerging patterns are used to perform a classification task to see how useful the patterns are in predicting whether a new cell is normal or cancerous.

As shown in Tables E and Table F, the frequency of the EP's is very large and hence the groups of genes are good indicators for classifying new tissues. It is useful to test the usefulness of the patterns by conducting a “Leave-One-Out-Cross-Validation” (LOOCV) classification task. By LOOCV, the first instance of the 62 tissues is identified as a test instance, and the remaining 61 instances are treated as training data. Repeating this procedure from the first instance through to the 62nd one, it is possible to get an accuracy, given by the percent of the instances which are correctly predicted.

In this example, the two sub-data sets respectively consisted of the normal training tissues and the cancerous training tissues. The validation correctly predicts 57 of the 62 tissues. Only three normal tissues (N1, N2, and N39) were wrongly classified as cancerous tissues, and two cancerous tissues (128 and T33) were wrongly classified as normal tissues. This result can be compared with a result in the literature. Furey et al. (see, Furey, T. S., Cristianini, N., Duffy, N., Bednarski, D. W., Schummer, M., and Haussler, D., “Support vector machine classification and validation of cancer tissue samples using microarray expression data,” Bioinformatics, 16:906-914, (2000)) mis-classified six tissues (T30, T33, T36, N8, N34, and N36), using 1,000 genes and a SVM approach. Interestingly all of the examples mis-classified by the method presented herein differ from those mis-classified by the SVM method, except for one (T33 was mis-classified by both). Thus the performance of the classification method presented herein is better than the SVM method.

It is to be stressed that the colon tumor data set is very complex. Normally and ideally, a test normal (or cancerous) tissue should contain a large number of EP's from the normal (or cancerous) training tissues, and a small number of EP's from the other type of tissues. However, based on the methods presented herein, a test tissue can contain many EP's, even the top-ranked highly frequent EP's, from the both classes of tissues.

Using the third method presented hereinabove, 58 of the 62 tissues are correctly predicted. Four normal tissues (N1, N12, N27, and N39) were wrongly classified as cancerous tissues. Thus the result of classification improves when strong EP's are used.

According to the classification results on the same data set, our method performs much better than a SVM method and a clustering method.

Boundary EP's

Alternatively, the CPS method selected 23 features from the 2,000 original genes as being the most important. All of the 23 features were partitioned into two intervals.

A total of 371 boundary EP's was discovered in the class of normal cells, and 131 boundary EP's in the cancerous cells class, using these 23 features. The total of 502 patterns are ranked according to the method described hereinabove. Some top ranked boundary EP's are presented in Table G.

TABLE G
The top 10 ranked boundary EP's in the normal class and in the
cancerous class are listed.

| | Occurrence | Occurrence |
|---|---|---|
| Boundary EP's | Normal (%) | Cancer (%) |
| {2, 6, 7, 11, 21, 23, 31} | 18 (81.8%) | 0 |
| {2, 6, 7, 21, 23, 25, 31} | 18 (81.8%) | 0 |
| {2, 6, 7, 9, 15, 21, 31} | 18 (81.8%) | 0 |
| {2, 6, 7, 9, 15, 23, 31} | 18 (81.8%) | 0 |
| {2, 6, 7, 9, 21, 23, 31} | 18 (81.8%) | 0 |
| {2, 6, 9, 21, 23, 25, 31} | 18 (81.8%) | 0 |
| {2, 6, 7, 11, 15, 31} | 18 (81.8%) | 0 |
| {2, 6, 11, 15, 25, 31} | 18 (81.8%) | 0 |
| {2, 6, 15, 23, 25, 31} | 18 (81.8%) | 0 |
| {2, 6, 15, 21, 25, 31} | 18 (81.8%) | 0 |
| {14, 34, 38} | 0 | 30 (75.0%) |
| {18, 34, 38} | 0 | 26 (65.0%) |
| {18, 32, 38, 40} | 0 | 25 (62.5%) |
| {18, 32, 44} | 0 | 25 (62.5%) |
| {20, 34} | 0 | 25 (62.5%) |
| {14, 18, 32, 38} | 0 | 24 (60.0%) |
| {18, 20, 32} | 0 | 23 (57.5%) |
| {14, 32, 34} | 0 | 22 (55.0%) |
| {14, 28, 34} | 0 | 21 (52.5%) |
| {18, 32, 34} | 0 | 20 (50.0%) |

Unlike the ALL/AML data, discussed in Example 3 hereinbelow, in the colon tumor data set there are no single genes that act as arbitrators to clearly separate normal and cancer cells. Instead, gene groups reveal contrasts between the two classes. Note that, as well as being novel, these boundary EP's, especially those having many conditions, are not obvious to biologists and medical doctors. Thus they may potentially reveal new biological functions and may have potential for finding new pathways.

P-Spaces

It can be seen that there are a total of ten boundary EP's having the same highest occurrence of 18 in the class of normal cells. Based on these boundary EP's, a P₁₈-space can be found in which the only most specific element is Z={2,6,7,9,11,15,21,23,25,31}. By convexity, any subset of Z that is also a superset of any one of the ten boundary EP's has an occurrence of 18 in the normal class. There are approximately one hundred EP's in this P-space. Alternatively, by convexity this space can be concisely represented using only 11 EP's, as shown in Table H.

TABLE H
A P₁₈-space in the normal class of the colon data.

| | Occurrence in |
|---|---|
| Most General and Most Specific EP's | Normal class |
| {2, 6, 7, 11, 21, 23, 31} | 18 |
| {2, 6, 7, 21, 23, 25, 31} | 18 |
| {2, 6, 7, 9, 15, 21, 31} | 18 |
| {2, 6, 7, 9, 15, 23, 31} | 18 |
| {2, 6, 7, 9, 21, 23, 31} | 18 |
| {2, 6, 9, 21, 23, 25, 31} | 18 |
| {2, 6, 7, 11, 15, 31} | 18 |
| {2, 6, 11, 15, 25, 31} | 18 |
| {2, 6, 15, 23, 25, 31} | 18 |
| {2, 6, 15, 21, 25, 31} | 18 |
| {2, 6, 7, 9, 11, 15, 21, 23, 25, 31} | 18 |

In Table H, the first 10 EP's are the most general elements, and the last one is the most specific element in the space. All of the EP's have the same occurrence in both normal and cancerous classes with frequencies 18 and 0 respectively.

From this P-space, it can be seen that significant gene groups (boundary EP's) can be expanded by adding some other genes without loss of significance, namely still keeping high occurrence in one class but absence in the other class. This may be useful in identifying a maximum length of a biological pathway.

Similarly, a P₃₀-space has been found in the cancerous class. The most general EP in this space is only {14, 34, 38} and the most specific EP is only {14, 30, 34, 36, 38, 40, 41,44, 45}. So, a boundary EP can add six more genes without changing its occurrence.

Shadow Patterns

It is also straightforward to find shadow patterns. Table J reports a boundary EP, shown as the first row, and its shadow patterns. These shadow patterns can also be used to illustrate the point that proper subsets of a boundary EP must occur in two classes at non-zero frequency.

TABLE J
A boundary EP and its three shadow patterns.

Occurrence

| Pattern | Normal | Cancer |
|---|---|---|
| {14, 34, 38} | 0 | 30 |
| {14, 34} | 1 | 30 |
| {14, 38} | 7 | 38 |
| {34, 38} | 5 | 31 |

For the colon data set, using the PCL method, a better LOOCV error rate can be obtained than other classification methods such as C4.5, Naive Bayes, k-NN, and support vector machines. The result is summarized in Table K, in which the error rate is expressed as the absolute number of false predictions.

TABLE K
Comparison of the error rate of PCL with other methods,
using LOOCV on the colon data set.

| Method | | Error Rate |
|---|---|---|
| C4.5 | | 20 |
| NB | | 13 |
| k-NN | | 28 |
| SVM | | 24 |
| PCL: | k = 5 | 13 |
| | k = 6 | 12 |
| | k = 7 | 10 |
| | k = 8 | 10 |
| | k = 9 | 10 |
| | k = 10 | 10 |

In addition, P-spaces can be used for classification. For example, for the colon data set, the ranked boundary EP's were replaced by the most specific elements of all P-spaces. In other words, instead of extracting boundary EP's, the most specific plateau EP's are extracted. The remaining steps of applying the PCL method are not changed. By LOOCV, an error rate of only six misclassifications is obtained. This reduction is significant in comparison to those of Table K.

### Example 3

A First Gene Expression Data Set (For Leukemia Patients)

A leukemia data set (Golub, T. R., Slonim, D. K., Tamayo, P., Huard, C., Gaasenbeek, M., Mesirov, J. P., Coller, H., Loh, M. L., Downing, J., Caligiuri, M. A., Bloomfield, C. D., & Lander, E. S., “Molecular classification of cancer: Class discovery and class prediction by gene expression monitoring,” Science, 286:531-537, (1999)), contains a training set of 27 samples of acute lymphoblastic leukemia (ALL) and 11 samples of acute myeloblastic leukemia (AML), as shown in Table C, hereinabove. (ALL and AML are two main subtypes of the leukemia disease.) This example utilized a blind testing set of 20 ALL and 14 AML samples. The high-density oligonucleotide microarrays used 7,129 probes of 6,817 human genes. This data is publicly available at http://www.genome.wi.mit.edu/MPR.

### Example 3.1

Patterns Derived from the Leukemia Data

The CFS method selects only one gene, Zyxin, from the total of 7,129 features. The discretization method partitions this feature into two intervals using a cut point at 994. Then, two boundary EP's, gene_zyxin@(−∞, 994) and gene_zyxin@[994, +∞), having a 100% occurrence in their home class, were discovered.

Biologically, these two EP's indicate that, if the expression of Zyxin in a sample cell is less than 994, then this cell is in the ALL class. Otherwise, this cell is in the AML class. This rule regulates all 38 training samples without any exceptions. If this rule is applied to the 34 blind testing samples, only three misclassifications were obtained. This result is better than the accuracy of the system reported in Golub et al., Science, 286:531-537, (1999).

Biological and technical noise sometimes happen in many stages in the experimental protocols that produce the data, both from machine and human origins. Examples include: the production of DNA arrays, the preparation of samples, the extraction of expression levels, and also from the impurity or misclassification of tissues. To overcome these possible errors—even where minor—it is suggested to use more than one gene to strengthen the classification method, as discussed hereinbelow.

Four genes were found whose entropy values are significantly less than those of all the other 7,127 features when partitioned by the entropy-based discretization method. These four genes, whose name, cut points, and item indexes are listed in Table L, were selected for pattern discovery. Each feature in Table L, is partitioned into two intervals using the cut points in column 2. The item index indicates the EP.

TABLE L
The four most discriminatory genes from the 7,129 features.

| Feature | Cut Point | Item Index |
|---|---|---|
| Zyxin | 994 | 1, 2 |
| Fah | 1346 | 3, 4 |
| Cst3 | 1419.5 | 5, 6 |
| Tropomyosin | 83.5 | 7, 8 |

A total of 6 boundary EP's were discovered, 3 each in the ALL and AML classes. Table M presents the boundary EP's together with their occurrence and the percentage of the occurrence in the whole class. The reference numbers contained in the patterns refers to the interval index in Table 2.

TABLE M
Three boundary EP's in the ALL class and three boundary
EP's in the AML class.

| Boundary EP's | Occurrence in ALL (%) | Occurrence in AML (%) |
|---|---|---|
| {5, 7} | 27 (100%) | 0 |
| {1} | 27 (100%) | 0 |
| {3} | 26 (96.3%) | 0 |
| {2} | 0 | 11 (100%) |
| {8} | 0 | 10 (90.9%) |
| {6} | 0 | 10 (90.9%) |

Biologically, the EP {5, 7} as an example says that if the expression of CST3 is less than 1419.5 and the expression of Tropomysin is less than 83.5 then this sample is ALL with 100% accuracy. So, all those genes involved in the boundary EP's derived by the method of the present invention are very good diagnostic indicators for classifying ALL and AML.

A P-space was also discovered based on the two boundary EP's {5, 7} and {1 }. This P-space consists of five plateau EP's: {1}, {1, 7}, {1, 5}, {5, 7}, and {1, 5, 7}. The most specific plateau EP is {1, 5, 7}. Note that this EP still has a full occurrence of 27 in the ALL class.

The accuracy of the PCL method is tested by applying it to the 34 blind testing sample of the leukemia data set (Golub et al., 1999) and by conducting a Leave-One-Out cross-validation (LOOCV) on the colon data set. When applied to the leukemia training data, the CFS method selected exactly one gene, Zyxin, which was discretized into two intervals, thereby forming a simple rule, expressable as: “if the level of Zyxin in a sample is below 994, then the sample is ALL; otherwise, the sample is AML”. Accordingly, as there is only one rule, there is no ambiguity in using it. This rule is 100% accurate on the training data. However, when applied to the set of blind testing data, it resulted in some classification errors. To increase accuracy, it is reasonable to use some additional genes. Recall that four genes in the leukemia data have also been selected as being the most important by the entropy-based discretization method. Using PCL on the boundary EP's derived from these four genes, a testing error rate of two misclassifications was obtained. This result is one error less than the result obtained by using the Zyxin gene alone.

### Example 4

A Second Gene Expression Data Set (For Subtypes of Acute Lymphoblastic Leukemia).

This example uses a large collection of gene expression profiles obtained from St Jude Children's Research Hospital (Yeoh A. E.-J. et al., “Expression profiling of pediatric acute lymphoblastic leukemia (ALL) blasts at diagnosis accurately predicts both the risk of relapse and of developing therapy-induced acute myeloid leukemia (AML),” Plenary talk at The American Society of Hematology 43rd Annual Meeting, Orlando, Fla., (December 2001)). The data comprises 327 gene expression profiles of acute lymphoblastic leukemia (ALL) samples. These profiles were obtained by hybridization on the Affymetrix U95A GeneChip containing probes for 12558 genes. The hybridization data were cleaned up so that (a) all genes with less than 3 “P” calls were replaced by 1; (b) all intensity values of “A” calls were replaced by 1; (c) all intensity values less than 100 were replaced by 1; (d) all intensity values more than 45,000 were replaced by 45,000; and (e) all genes whose maximum and minimum intensity values differ by less than 100 were replaced by 1. These 327 gene expression profiles contain all the known acute lymphoblastic leukemia subtypes, including T-cell (T-ALL), E2A-PBX1, TEL-AML1, MLL, BCR-ABL, and hyperdiploid (Hyperdip>50).

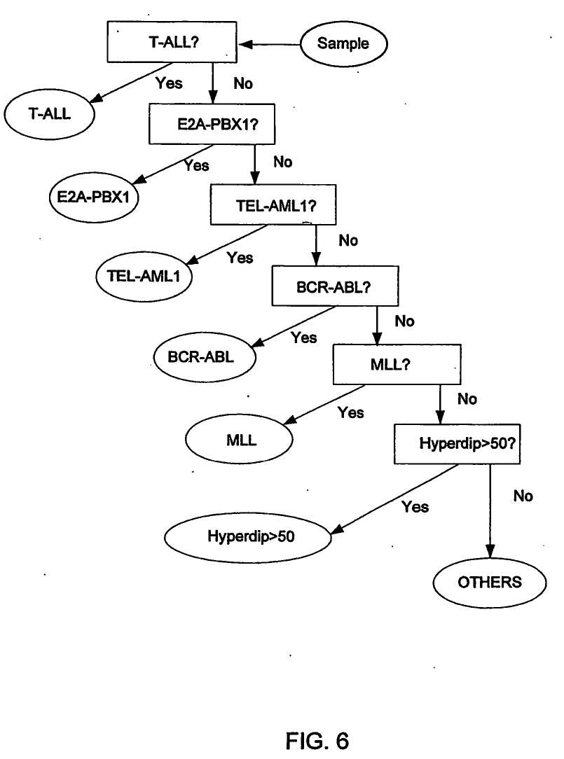

A tree-structured decision system has been used to classify these samples, as shown in FIG. 6. For a given sample, rules are applied firstly for classifying whether it is a T-ALL or a sample of other subtypes. If it is classified as T-ALL, then the process is terminated. Otherwise, the process is moved to level 2 in the tree to see whether the sample can be classified as E2A-PBX1 or one of the remaining other subtypes. With similar reasoning, a decision process based on this tree can be terminated at level 6 where the sample is determined to be either of subtype Hyperdip>50 or, simply “OTHERS”.

The samples are divided into a “training set” of 215 samples and a blind “testing set” of 112 samples. In accordance with FIG. 6, it is necessary to further subdivide each of the two sets into six pairs of subsets, one for each level of the tree. Their names and ingredients are given in Table N.

TABLE N
Six pairs of training data sets and blind testing sets.

| | | Training set | Testing set |
|---|---|---|---|
| Paired data sets | Ingredients | size | size |
| T-ALL vs. | OTHERS1 = {E2A-PBXI, TEL-AMLI, BCR- | 28 vs 187 | 15 vs 97 |
| OTHERS1 | ABL, Hyperdip > 50, MLL, OTHERS} | | |
| E2A-PBXS vs. | OTHERS2 = {TEL-AML1, BCR.ABL, | 18 vs 169 | 9 vs 88 |
| OTHERS2 | Hyperdip > 50, MLL, OTHERS} | | |
| TEL-AML1 vs. | OTHERS3 = {HCR-ABL, Hyperdip > 50, | 52 vs 117 | 27 vs 61 |
| OTHERS3 | MLL, OTHERS} | | |
| BCR-ABL vs. | OTHERS4 = {Hyperdip > 50, MLL, OTHERS} | 9 vs 108 | 6 vs 55 |
| OTHERS4 | | | |
| MLL vs. | OTHERS5 = {Hyperdip > 50, OTHERS} | 14 vs 94 | 6 vs 49 |
| OTHERS5 | | | |
| Hyperdip > 50 vs. | OTHERS = {Hyperdip47-50, Pseudodip, | 42 vs 52 | 22 vs 27 |
| OTHERS | Hypodip, Normo} | | |

The “OTHERS1”, “OTHERS2”, “OTHERS3”, “OTHERS4”, “OTHERS5” and “OTHERS” classes in Table N consist of more than one subtypes of ALL samples, as shown in the second column of the table.

### Example 4.1

EP Generation

The emerging patterns are produced in two steps. In the first step, a small number of the most discriminatory genes are selected from among the 12,558 genes in the training set. In the second step, emerging patterns based on the selected genes are produced.

The entropy-based gene selection method was applied to the gene expression profiles. It proved to be very effective because most of the 12,558 genes were ignored. Only about 1,000 genes were considered to be useful in the classification. The 10% selection rate provides a much easier platform to derive important rules. Nevertheless, to manually examine 1,000 or so genes is still tedious. Accordingly, the Chi-Squared (χ²) method (Liu & Setiono, “Chi2: Feature selection and discretization of numeric attributes.” Proceedings of the IEEE 7^{th} International Conference on Tools with Artificial Intelligence, 338-391, (1995); Witten, H., & Frank, E., Data mining: Practical machine learning tools and techniques with java implementation, Morgan Kaufmann, San Mateo, Calif., (2000)) and the Correlation-based Feature Selection (CFS) method (Hall, Correlation-based feature selection machine learning, Ph.D. Thesis, Department of Computer Science, University of Waikato, Hamilton, New Zealand, (1998); Witten & Frank, 2000) are used to further narrow the search for the important genes. In this study, if the CFS method returns a number of genes not larger than 20, then the CFS-selected genes are used for deriving our emerging patterns. Otherwise the top 20 ranked genes by the χ² method are used.

In this example, a special type of EP's, called jumping “left-boundary” EP's, is discovered. Given two data sets D₁ and D₂, these EP's are required to satisfy the following conditions: (i) their frequency in D₁ (or D2) is non-zero but in another data set is zero; (ii) none of their proper subsets is an EP. It is to be noted that jumping left-boundary EP's are the EP's with the largest frequencies among all EP's. Furthermore, most of the supersets of the jumping left-boundary EP's are EP's unless they have zero frequency in both D₁ and D₂.

After selecting and discretizing the most discriminatory genes, the BORDER-DIFF and the JEP-PRODUCER algorithms (Dong & Li, ACM SIGKDD International Conference on Knowledge Discovery and Data Mining, San Diego, 43-52 (1999); Li, Mining Emerging Patterns to Construct Accurate and Efficient Classifiers, Ph.D. Thesis, The University of Melbourne, Australia, (2001); Li et al., “The Space of Jumping Emerging Patterns and Its Incremental Maintenance Algorithms,” Proceedings of 17^{th} International Conference on Machine Learning, 552-558 (2000)) were used to discover EP's from the processed data sets. As most of the manipulation is of borders, these algorithms are very efficient.

### Example 4.2

Rules Derived from EP's

This section reports the discovered EP's from the training data. The patterns can be expanded to form rules for distinguishing the gene expression profiles of various subtypes of ALL.

Rules for T-ALL vs. OTHERS1:

For the first pair of data sets, T-ALL vs OTHERS1, the CFS method selected only one gene, 38319_at, as the most important. The discretization method partitioned the expression range of this gene into two intervals: (−∞, 15975.6) and [15975.6, +∞). Using the EP discovery algorithms, two EP's were derived: {gene_{—}_{³⁸³¹⁹}_{—}_{^{at}}@(−∞, 15975.6)} and {gene_{—}_{³⁸³¹⁹}_{—}_{^{at}}@(15975.6, +∞)}. The former has a 100% frequency in the T-ALL class but a zero frequency in the OTHERS1 class; the latter has a zero frequency in the T-ALL class, but a 100% frequency in the OTHERS1 class. Therefore, we have the following rule:
If the expression of 38319_at is less than 15975.6, then
   this ALL sample must be a T-ALL;
Otherwise
   it must be a subtype in OTHERS1.

This simple rule regulates the 215 ALL samples (28 T-ALL plus 187 OTHERS1) without any exception.

Rules for E2A-PBX1 vs OTHERS2.

There is also a simple rule for E2A-PBX1 vs. OTHERS2. The method picked one gene, 33355_at, and discretized it into two intervals: (−∞, 10966) and [10966, +∞). Then {gene_{—}_{³³³⁵⁵}_{—}_{^{at}}@(−∞, 10966)} and {gene_{—}_{³³⁵⁵⁵}_{—}_{^{at}}@10966, +∞)} were found to be EP's with 100% frequency in E2A-PBX1 and OTHERS2 respectively. So, a rule for these 187 ALL samples (18 E2A-PBX1 plus 169 OTHERS2) would be:
If the expression of 33355_at is less than 10966, then:
   this ALL sample must be a E2A-PBX1;
Otherwise
   it must be a subtype in OTHERS2.
      Rules Through Level 3 to Level 6.

For the remaining four pairs of data sets, the CPS method returned more than 20 genes. So, the χ² method was used to select 20 top-ranked genes for each of the four pairs of data sets. Table O, Table P, Table Q, and Table R list the names of the selected genes, their partitions, and an index to the intervals for the four pairs of data sets respectively. As the index matches and joins the genes' name and their intervals, it is more convenient to read and write EP's using the index.

TABLE O
The top 20 genes selected by the χ² method from TEL-AML1 vs OTHERS3.
The intervals produced by the entropy method and the index to the intervals are
listed in columns 2 and 3.

| Gene Names | Intervals | Index to Intervals |
|---|---|---|
| 38652_at | (−∞, 8997.35), [8997.35, +∞) | 1, 2 |
| 36239_at | (−∞, 14045.5), [14045.5, 16328.55), [16328.55, +∞) | 3, 4, 5 |
| 41442_at | (−∞, 15114.1), [15114.1, 26083.95), [26083.95, +∞) | 6, 7, 8 |
| 37780_at | (−∞, 2396.3), [2396.3, 5140.5), [5140.5, +∞) | 9, 10, 11 |
| 36985_at | (−∞, 19499.6), [19499.6, 26571.05), [26571.05, +∞) | 12, 13, 14 |
| 38578_at | (−∞, 7788.95), [7788.95, +∞) | 15, 16 |
| 38203_at | (−∞, 3721.3), [3721.3, +∞) | 17, 18 |
| 35614_at | (−∞, 9930.15), [9930.15, +∞) | 19, 20 |
| 32224_at | (−∞, 5740.45), [5740.45, +∞) | 21, 22 |
| 32730_at | (−∞, 2864.85), [2864.85, +∞) | 23, 24 |
| 35665_at | (−∞, 5699.35), [5699.35, +∞) | 25, 26 |
| 1077_at | (−∞, 22027.55), [22027.55, +∞) | 27, 28 |
| 36524_at | (−∞, 1070.65), [1070.65, +∞) | 29, 30 |
| 34194_at | (−∞, 1375.85), [1375.85, +∞) | 31, 32 |
| 36937_a_at | (−∞, 13617.05), [13617.05, +∞) | 33, 34 |
| 36008_at | (−∞, 11675.35), [11675.35, +∞) | 35, 36 |
| 1299_at | (−∞, 3647.7), [3647.7, 9136.35), [9136.35, +∞) | 37, 38, 39 |
| 41814_at | (−∞, 6873.85), [6873.85, +∞) | 40, 41 |
| 41200_at | (−∞, 11030.5), [11030.5, +∞) | 42, 43 |
| 35238_at | (−∞, 4774.85), [4774.85, 7720.4), [7720.4, +∞) | 44, 45, 46 |

TABLE P
The top 20 genes selected by the χ² method from the data pair
BCR-ABL vs OTHERS4.

| Gene Names | Intervals | Index to Intervals |
|---|---|---|
| 1637_at | (−∞, 5242.15), [5242.15, +∞) | 1, 2 |
| 36650_at | (−∞, 13402), [13402, +∞) | 3, 4 |
| 40196_at | (−∞, 2424.4), [2424.4, +∞) | 5, 6 |
| 1635_at | (−∞, 5279.3), [5279.3, +∞) | 7, 8 |
| 33775_s_at | (−∞, 1130.75), [1130.75, +∞) | 9, 10 |
| 1636_{g}_at | (−∞, 11112.9), [11112.9, +∞) | 11, 12 |
| 41295_at | (−∞, 33488.7), [33488.7, +-∞) | 13, 14 |
| 37600_at | (−∞, 24168.95), [24168.95, +∞) | 15, 16 |
| 37012_at | (−∞, 18127.7), [18127.7, +-∞) | 17, 18 |
| 39225_at | (−∞, 14137.25), (14137.25, +∞) | 19, 20 |
| 1326_at | (−∞, 3273.55), [3273.55, +∞) | 21, 22 |
| 34362_at | (−∞, 13254.9), [13254.9, +∞) | 23, 24 |
| 33150_at | (−∞, +∞) | 25 |
| 40051_at | (−∞, +∞) | 26 |
| 39061_at | (−∞, +∞) | 27 |
| 33172_at | (−∞, +∞) | 28 |
| 37399_at | (−∞, +∞) | 29 |
| 317_at | (−∞, +∞) | 30 |
| 40953_at | (−∞, 2569.55), [2569.55, +∞) | 31, 32 |
| 330_s_at | (−∞, 6237.5), [6237.5, +∞) | 33, 34 |

TABLE Q
The top 20 genes selected by the χ² method from MLL vs OTHERS5.

| Gene Names | Intervals | Index to Intervals |
|---|---|---|
| 34306_at | (−∞, 12080.7), [12080.7, +∞) | 1, 2 |
| 40797_at | (−∞, 5331.15), [5331.15, +∞) | 3, 4 |
| 33412_at | (−∞, 29321.15), [29321.15, +∞) | 5, 6 |
| 39338_at | (−∞, 5813.1), [5813.1, +∞) | 7, 8 |
| 2062_at | (−∞, 10476.05), [10476.05, +∞) | 9, 10 |
| 32193_at | (−∞, 2605.6), 2605.6, +∞) | 11.12 |
| 40518_at | (−∞, 23228.2), [23228.2, +∞) | 13, 14 |
| 36777_at | (−∞, 5873.9), [5873.9, +∞) | 15, 16 |
| 32207_at | (−∞, 7238.8), [7238.8, +∞) | 17, 18 |
| 33859_at | (−∞, 23053.2), [23053.2, 24674.9), [24674.9, +∞) | 19, 20, 21 |
| 38391_at | (−∞, 16251.65), [16251.65, +∞) | 22, 23 |
| 40763_at | (−∞, 3301.3), [3301.3, +∞) | 24, 25 |
| 1126_s_at | (−∞, 6667.6), [6667.6, +∞) | 26, 27 |
| 34721_at | (−∞, 8743.05), [8743.05, +∞) | 28, 29 |
| 37809_at | (−∞, 2705.75), [2705.75, +∞) | 30, 31 |
| 34861_at | (−∞, 4780), [4780, 5075.05), [5075.05, +∞) | 32, 33, 34 |
| 38194_s_at | (−∞, 859.2), [859.2, 6860.6), [6860.6, +∞) | 35, 36, 37 |
| 657_at | (−∞, 8829.8), [8829.8, +∞) | 38, 39 |
| 36918_at | (−∞, 5321.15), [5321.15, +∞) | 40, 41 |
| 32215_i_at | (−∞, 2464.1), [2464.1, +∞) | 42, 43 |

TABLE R
The top 20 genes selected by the χ² method from the data pair
Hyperdip > 50 vs OTHERS.

| Gene Names | Intervals | Index to Intervals |
|---|---|---|
| 36620_at | (−∞, 16113.1), (16113.1, +∞) | 1.2 |
| 37350_at | (−∞, 10351.95), [10351.95, +∞) | 3, 4 |
| 171_at | (−∞, 6499.25), [6499.25, +∞) | 5, 6 |
| 37677_at | (−∞, 41926.9), [41926.9, +∞) | 7, 8 |
| 41724_at | (−∞, 20685.45), [20685.45, +∞) | 9, 10 |
| 32207_at | (−∞, 15242.9), [15242.9, +∞) | 11, 12 |
| 38738_at | (−∞, 15517.2), [15517.2, +∞) | 13, 14 |
| 40480_s_at | (−∞, 4591.95), [4591.91, +∞) | 11, 16 |
| 38518_at | (−∞, 13840), [13840, +∞) | 17, 28 |
| 41132_r_at | (−∞, 10490.95), [10490.95, +∞) | 19, 20 |
| 31492_at | (−∞, 17667.05), [17667.05, +∞) | 21, 22 |
| 38317_at | (−∞, 4982.05), [4982.05, +∞) | 23, 24 |
| 40998_at | (−∞, 11962.6), [11962.6, +∞) | 28, 26 |
| 35688_g_at | (−∞, 3340.55), [3340.55, +∞) | 27, 28 |
| 40903_at | (−∞, 3660.4), [3660.4, +∞) | 29, 30 |
| 36489_at | (−∞, 6841.95), [6841.95, +∞) | 31, 32 |
| 1520_s_at | (−∞, 10334.05), [10334.05, +∞) | 23, 34 |
| 35939_s_at | (−∞, 9821.95), [9821.95, +∞) | 31, 36 |
| 38604_at | (−∞, 13569.7), [13569.7, +∞) | 37, 38 |
| 31863_at | (−∞, 8057.7), [8057.7, +∞) | 39, 40 |

After discretizing the selected genes, two groups of EP's were discovered for each of the four pairs of data sets. Table S shows the numbers of the discovered emerging patterns. The fourth column of Table S shows that the number of the discovered EP's is relatively large. We use another four tables in Table T, Table U, Table V, and Table W to list the top 10 EP's according to their frequency. The frequency of these top-10 EP's can reach 98.94% and most of them are around 80%. Even though a top-ranked EP may not cover an entire class of samples, it dominates the whole class. Their absence in the counterpart classes demonstrates that top-ranked emerging patterns can capture the nature of a class.

TABLE S
Total number of left-boundary EP's discovered from the four pairs
of data sets.

| Data set pair | Number of | Number of | |
|---|---|---|---|
| (D₁ vs D₂) | EP's in D₁ | EP's in D₂ | Total |
| TEL-AML1 vs OTHERS3 | 2178 | 943 | 3121 |
| BCR-ABL vs OTHERS4 | 101 | 230 | 313 |
| MLL vs OTHERS5 | 155 | 597 | 752 |
| Hyperdip > 50 vs OTHERS | 2213 | 2158 | 4371 |

TABLE T
Ten most frequent EP's in the TEL-AML and OTHERS3 classes.

| | % frequency | % frequency | | % frequency | % frequency |
|---|---|---|---|---|---|
| EP's | in TEL-AML1 | in OTHERS3 | EP's | in TEL-AML1 | in OTHERS3 |
| {2, 33} | 92.31 | 0.00 | {1, 23, 40} | 0.00 | 88.89 |
| {16, 22, 33} | 90.38 | 0.00 | {17, 29} | 0.00 | 88.89 |
| {20, 22, 33} | 88.46 | 0.00 | {1, 17, 40} | 0.00 | 88.03 |
| {5, 33} | 86.54 | 0.00 | {1, 9, 40} | 0.00 | 88.03 |
| {22, 28, 33} | 84.62 | 0.00 | {15, 17} | 0.00 | 88.03 |
| {16, 33, 43} | 82.69 | 0.00 | {1, 23, 29} | 0.00 | 87.18 |
| {22, 30, 33} | 82.69 | 0.00 | {17, 25, 40} | 0.00 | 87.18 |
| {2, 36} | 82.69 | 0.00 | {7, 23, 40} | 0.00 | 87.18 |
| {20, 43} | 82.69 | 0.00 | {9, 17, 40} | 0.00 | 87.18 |
| {22, 36} | 82.69 | 0.00 | {1, 9, 29} | 0.00 | 87.18 |

TABLE U
Ten most frequent EP's in the BCR-ABL and OTHERS4 classes.

| | % frequency | % frequency | | % frequency | % frequency in |
|---|---|---|---|---|---|
| EP's | in BCR-ABL | in OTHERS4 | EP's | in BCR-ABL | OTHERS4 |
| {22, 32, 34} | 77.78 | 0.00 | {3, 5, 9} | 0.00 | 95.37 |
| {8, 12} | 77.78 | 0.00 | {3, 9, 19} | 0.00 | 95.37 |
| {4, 8, 34} | 66.67 | 0.00 | {3, 15} | 0.00 | 95.37 |
| {4, 8, 22} | 66.67 | 0.00 | {3, 13} | 0.00 | 95.37 |
| {6, 34} | 66.67 | 0.00 | {3, 5, 23} | 0.00 | 93.52 |
| {8, 24} | 66.67 | 0.00 | {11, 17, 19} | 0.00 | 93.52 |
| {24, 32} | 66.67 | 0.00 | {3, 19, 23} | 0.00 | 93.52 |
| {4, 12} | 66.67 | 0.00 | {7, 19} | 0.00 | 93.52 |
| {8, 32} | 66.67 | 0.00 | {11, 15} | 0.00 | 93.52 |
| {12, 34} | 66.67 | 0.00 | {5, 11} | 0.00 | 93.52 |

TABLE V
Ten most frequent EP's in the MLL and OTHERS5 classes.

| | % frequency in | % frequency in | | % frequency in | % frequency in |
|---|---|---|---|---|---|
| EP's | MLL | OTHERS5 | EP's | MLL | OTHERS5 |
| {2, 14} | 85.71 | 0.00 | {5, 24} | 0.00 | 98.94 |
| {12, 14} | 71.43 | 0.00 | {5, 22, 38} | 0.00 | 96.81 |
| {2, 39} | 64.29 | 0.00 | {24, 28, 42} | 0.00 | 96.81 |
| {14, 16} | 64.29 | 0.00 | {5, 28, 30} | 0.00 | 96.81 |
| {16, 17} | 64.29 | 0.00 | {5, 7, 30} | 0.00 | 96.81 |
| {4, 36} | 64.29 | 0.00 | {24, 26, 42} | 0.00 | 96.81 |
| {4, 8} | 64.29 | 0.00 | {7, 15, 24} | 0.00 | 96.81 |
| {14, 36} | 64.29 | 0.00 | {15, 24, 26} | 0.00 | 96.81 |
| {8, 36} | 57.14 | 0.00 | {15, 24, 28} | 0.00 | 96.81 |
| {2, 31} | 57.14 | 0.00 | {7, 24, 42} | 0.00 | 96.81 |

TABLE W
Ten most frequent EP's in the Hyperdip>50 and OTHERS classes.

| | % frequency in | % frequency in | | % frequency in | % frequency |
|---|---|---|---|---|---|
| EP's | Hyperdip > 50 | OTHERS | EP's | Hyperdip > 50 | in OTHERS |
| {14, 24} | 78.57 | 0.00 | {15, 17, 25} | 0.00 | 78.85 |
| {2, 12, 14} | 71.43 | 0.00 | {7, 15} | 0.00 | 76.92 |
| {12, 14, 38} | 71.43 | 0.00 | {5, 15} | 0.00 | 76.92 |
| {4, 14} | 71.43 | 0.00 | {1, 15} | 0.00 | 76.92 |
| {12, 14, 34} | 69.05 | 0.00 | {15, 33} | 0.00 | 76.92 |
| {12, 14, 16} | 69.05 | 0.00 | {3, 15} | 0.00 | 76.92 |
| {2, 8, 14} | 69.05 | 0.00 | {15, 17, 31} | 0.00 | 75.00 |
| {14, 32} | 69.05 | 0.00 | {15, 17, 19} | 0.00 | 75.00 |
| {10, 21, 24} | 66.67 | 0.00 | {15, 17, 27} | 0.00 | 75.00 |
| {12, 21, 24} | 66.67 | 0.00 | {15, 39} | 0.00 | 75.00 |

As an illustration of how to interpret the EP's into rules, consider the first EP of the TEL/AML1 class, i.e., {2, 33 }. According to the index in Table O, the number 2 in this EP matches the right interval of the gene 38652_at, and stands for the condition that: the expression of 38652_at is larger than or equal to 8,997.35. Similarly, the number 33 matches the left interval of the gene 36937_s_at, and stands for the condition that the expression of 36937_s_at is less than 13,617.05. Therefore the pattern {2, 33} means that 92.31% of the TEL/AML1 class (48 out of the 52 samples) satisfy the two conditions above, but no single sample from OTHERS3 satisfies both of these conditions. Accordingly, in this case, a whole class can be fully covered by a small number of the top-10 EP's. These EP's are the rules that are desired

An important methodology to test the reliability of the rules is to apply them to previously unseen samples (Le., blind testing samples). In this example, 112 blind testing samples were previously reserved. A summary of the testing results is as follows:

At level 1, all the 15 T-ALL samples are correctly predicted as T-ALL; all the 97 OTHERS1 samples are correctly predicted as OTHERS1.

At level 2, all the 9 E2A-PBX1 samples are correctly predicted as E2A-PBX1; all the 88 OTHERS2 samples are correctly predicted as OTHERS2.

For levels 3 to 6, only 4-7 samples are misclassified, depending on the number of EP's used. By using a greater number EP's, the error rate decreased

One rule was discovered at each of levels 1 and 2, so there was no ambiguity in using these two rules. However, a large number of EP's were found at the remaining levels of the tree. Accordingly, since a testing sample may contain not only EP's from its own class, but also EP's from its counterpart class, to make reliable predictions, it is reasonable to use multiple highly frequent EP's of the “home” class to avoid the confusing signals from counterpart EP's. Thus, the method of PCL was applied to levels 3 to 6.

The testing accuracy when varying k, the number of rules to be used, is shown in Table X. From the results, it can be seen that multiple highly frequent EP's (or multiple strong rules) can provide a compact and powerful prediction likelihood. With k of 20, 25, and 30, a total of 4 misclassifications was made. The id's of the four testing samples are: 94-0359-U95A, 89-0142-U95A, 91-0697-U95A, and 96-0379-U95A, using the notation of Yeoh et al., The American Society of Hematology 43rd Annual Meeting, 2001.

TABLE X
The number of EP's used to calculate the scores can slightly affect
the prediction accuracy. Error rate, x:y, means that x number of
samples in the right-side class are misclassified, and y number of
samples in the left-side class misclassified.

| | Error rate when varing k | | | | | |
|---|---|---|---|---|---|---|
| Testing Data | 5 | 10 | 15 | 20 | 25 | 30 |
| TEL-AML1 vs OTHERS3 | 2:0 | 2:0 | 2:0 | 1:0 | 1:0 | 1:0 |
| BCR-ABL vs OTHERS4 | 3:0 | 2:0 | 2:0 | 2:0 | 2:0 | 2:0 |
| MLL vs OTHERS5 | 1:0 | 0:0 | 0:0 | 0:0 | 0:0 | 0:0 |
| Hyperdip > 50 vs OTHERS | 0:1 | 0:1 | 0:1 | 0:1 | 0:1 | 0:1 |

Generalization to Multi-Class Prediction

A BCR-ABL test sample contained almost all of the top 20 BCR-ABL discriminators. So, a score of 19.6 was assigned to it. Several top-20 “OTHERS” discriminators, together with some beyond the top-20 list were also contained in this test sample. So, another score of 6.97 was assigned. This test sample did not contain any discriminators of E2A-PBX1, Hyperdip>50, or T-ALL. So the scores are as follows, in Table Y.

TABLE Y

| | BCR- | E2A- | Hyperdip | T- | | TEL- | |
|---|---|---|---|---|---|---|---|
| Subtype | ABL | PBX1 | >50 | ALL | MLL | AML1 | OTHERS |
| Score | 19.63 | 0.00 | 0.00 | 0.00 | 0.71 | 2.96 | 6.97 |

Therefore, this BCR-ABL sample was correctly predicted as BCR-ABL with very high confidence. By this method, only 6 to 8 misclassifications were made for the total 112 testing samples when varying k from 15 to 35. However, C4.5, SVM, NB, and 3-NN made 27, 26, 29 and 11 mistakes, respectively.

Improvements to Classification:

At levels 1 and 2, only one gene was used for the classification and prediction. To overcome possible errors such as human errors in recording data, or machine errors by the DNA-chips that rarely occur but which may be present, more than one gene may be used to strengthen the system.

The previously selected one gene 38319_at at level 1 has an entropy of 0 when it is partitioned by the discretization method. It turns out that there are no other genes which have an entropy of 0. So the top 20 genes ranked by the χ² method were selected to classify the T-ALL and OTHERS1 testing samples. From this, 96 EP's and 146 EP's were discovered in the T-ALL class, and in the OTHERS1 class, respectively. Using the prediction method, the same perfect accuracy 100% on the blind testing samples was achieved as when the single gene was used.

At level 2 there are a total of five genes which have zero entropy when partitioned by the discretization method. The names of the five genes are: 430_at, 1287_at, 33355_at, 41146_at, and 32063_at. Note that 33355_at is our previously selected one gene. All of the five genes are partitioned into two intervals with the following cut points respectively: 30,246.05, 34,313.9, 10,966, 25,842.15, and 4,068.7. As the entropy is zero, there are five EP's in the E2A-PBX1 class and in the OTHERS2 class with 100% frequency. Using the PCL prediction method, all the testing samples (at level 2) were correctly classified without any mistakes, once again achieving perfect 100% accuracy.

Comparison with Other Methods:

In Table Z the prediction accuracy is compared with the accuracy achieved by k-NN, C4.5, NB, and SVM using the same selected genes and the same training and testing samples. The PCL method reduced the misclassifications by 71 % from C4.5's 14, by 50% from NB's 8, by 43% from k-NN's 7, and by 33% from SVM's 6.1. From the medical treatment point of view, this error reduction would benefit patients greatly.

TABLE Z
Error rates comparison of our method with k-NN, C4.5, NB,
and SVM on the testing data.

| | Error rate of different models | | | | |
|---|---|---|---|---|---|
| | | | | | Ours |
| Testing Data | k-NN | C4.5 | SVM | NB | (k = 20, 25, 30) |
| T-ALL vs OTHERS1 | 0:0 | 0:1 | 0:0 | 0:0 | 0:0 |
| E2A-PBXI vs OTHERS2 | 0:0 | 0:0 | 0:0 | 0:0 | 0:0 |
| TEL-AML1 vs OTHERS3 | 0:2 | 1:1 | 0:1 | 0:1 | 1:0 |
| BCR-ABL vs OTHERS4 | 4:0 | 2:0 | 3:0 | 1:4 | 2:0 |
| MLL vs OTHERS5 | 0:0 | 0:1 | 0:0 | 0:0 | 0:0 |
| Hyperdip > 50 vs OTHERS | 0:1 | 2:6 | 0:2 | 0:2 | 0:1 |
| Total Errors | 7 | 13 | 6 | 8 | 4 |

As discussed earlier, an obvious advantage of the PCL method over SVM, NB, and k-NN is that meaningful and reliable patterns and rules can be derived. Those emerging patterns can provide novel insight into the correlation and interaction of the genes and can help understand the samples in greater detail than can a mere classification. Although C4.5 can generate similar rules, as it sometimes performs badly (e.g., at level 6), its rules are not very reliable.

Assessing the Use of the Top 20 Genes.

Much effort and computation to identify the most important genes has been made. The experimental results have shown that the selected top gene, or top 20 genes, are very useful in the PCL prediction method. An alternative way to judge the quality of the selected genes is possible, however. In this case, the accuracy difference if 20 genes or 1 gene is randomly picked from the training data, is investigated.

The procedure is: (a) randomly select one gene at level 1 and level 2, and randomly select 20 genes at each of the four remaining levels; (b) run SVM and k-NN, obtain their accuracy on the testing samples of each level; and (c) repeat (a) and (b) a hundred times, and calculate averages and other statistics.

Table AA shows the minimum, maximum, and average accuracy over the 100 experiments by SVM and k-NN. For comparison, the accuracy of a “dummy” classifier is also listed. By the dummy classifier, all testing samples are trivially predicted as the bigger class if two unbalanced classes of data are given. The following two important facts become apparent. First, all of the average accuracies are below or only slightly above their dummy accuracies. Second, all of the average accuracies are significantly (at least 9%) below the accuracies based on the selected genes. The difference can reach 30%. Therefore, the gene selection method worked effectively with the prediction methods. Feature selection methods are important preliminary steps before reliable and accurate prediction models are established.

TABLE AA
Performance based on random gene selection.

| Statistics | Level 1 | Level 2 | Level 3 | Level 4 | Level 5 | Level 6 |
|---|---|---|---|---|---|---|
| Dummy (%) | 86.6 | 90.7 | 69.3 | 90.2 | 89.1 | 55.1 |
| | Testing Accuracy(%) by SVM | | | | | |
| min | 82.1 | 90.7 | 40.9 | 72.6 | 76.4 | 49.0 |
| max | 90.2 | 92.8 | 93.2 | 91.94 | 98.2 | 93.9 |
| average | 86.6 | 90.8 | 73.35 | 84.32 | 89.0 | 67.8 |
| | Testing Accuracy(%) by k-NN | | | | | |
| min | 74.1 | 78.4 | 46.6 | 88.7 | 69.1 | 38.8 |
| max | 93.8 | 92.8 | 89.8 | 90.3 | 96.36 | 81.6 |
| average | 84.7 | 89.4 | 66.5 | 90.3 | 84.2 | 60.2 |

It is also possible to compute the accuracy if the original data with 12,558 genes is applied to the prediction methods. Experimental results show that the gene selection method also makes a big difference. For the original data, SVM, k-NN, NB, and C4.5 make respectively 23, 23, 63, and 26 misclassifications on the blind testing samples. These results are much worse than the error rates of 6, 7, 8, and 13 if the reduced data are applied respectively to SVM, k-NN, NB, and C4.5. Accordingly, gene selection methods are important for establishing reliable prediction models.

Finally, the method based on emerging patterns has the advantage of both high accuracy and easy interpretation, especially when applied to classifying gene expression profiles. When tested on a large collection of ALL samples, the method accurately classified all its sub-types and achieved error rates considerably less than the C4.5, NB, SVM, and k-NN methods. The test was performed by reserving roughly ⅔ of the data for training and the remaining ⅓ for blind testing. In fact, a similar improvement in error rates was also observed in a 10-fold cross validation test on the training data, as shown in Table BB.

TABLE BB
10-fold cross validation results on the training set of 215 ALL samples.

| | Error rates by 10-fold cross validation | | | | |
|---|---|---|---|---|---|
| | | | | | Ours |
| Training Data | k-NN | C4.5 | SVM | NB | (k = 20, 25, 30) |
| T-ALL vs OTHERS1 | 0:0 | 0:1 | 0:0 | 0:0 | 0:0, 0:0, 0:0 |
| E2A-PBXI vs OTHERS2 | 0:0 | 0:1 | 0:0 | 0:0 | 0:0, 0:0, 0:0 |
| TEL-AML1 vs OTHERS3 | 1:4 | 3:5 | 0:4 | 0:7 | 1:3, 0:3, 0:3 |
| BCR-ABL vs OTHERS4 | 6:0 | 5:4 | 2:1 | 0:4 | 1:0, 1:0, 1:0 |
| MLL vs OTHERS5 | 2:0 | 3:10 | 0:0 | 0:3 | 4:0, 2:0, 2:0 |
| Hyperdip > 50 vs OTHERS | 7:5 | 13:8 | 6:4 | 6:7 | 3:4, 3:4, 3:4 |
| Total Errors | 25 | 53 | 17 | 27 | 16, 13, 13 |

It will be readily apparent to one skilled in the art that varying substitutions and modifications may be made to the invention disclosed herein without departing from the scope and spirit of the invention. For example, use of various parameters, data sets, computer readable media, and computing apparatus are all within the scope of the present invention. Thus, such additional embodiments are within the scope of the present invention and the following claims.

1. A method of determining whether a test sample, having test data T, is categorized in one of a number n of classes wherein n is 2 or more, comprising:
extracting a plurality of emerging patterns from a training data set D that has at least one instance of each of said n classes of data;
creating n lists, wherein:
an ith list of said n lists contains a frequency of occurrence, ƒᵢ(m), of each emerging pattern EPᵢ(m) from said plurality of emerging patterns that has a non-zero occurrence in an ith class of data;
using a fixed number, k, of emerging patterns, wherein k is substantially less than a total number of emerging patterns in the plurality of emerging patterns, calculating n scores; wherein:
an ith score of said n scores is derived from the frequencies of k emerging patterns in said ith list that also occur in said test data; and
deducing which of said n classes of data the test data is categorized in, by selecting the highest of said n scores.

2. The method of claim 1, additionally comprising:
if there is more than one class with the highest score, deducing which of said n classes of data the test data is categorized in by selecting the largest of the classes of data having the highest score.

3. The method of claim 1, wherein:
said k emerging patterns of the ith list that occur in said test data have the highest frequencies of occurrence in said ith list amongst all those emerging patterns of said ith list that occur in said test data, for all i.

4. The method of claim 1, wherein:
emerging patterns in the ith list are ordered in descending order of said frequency of occurrence in said ith class of data, for all i.

5. The method of claim 1, wherein the ith list has a length lᵢ, and k is a fixed percentage of the smallest lᵢ.

6. The method of claim 1, wherein the ith list has a length lᵢ, and k is a fixed percentage of
$${\sum }_{i = 1}^{n} {1}_{i} .$$

7. The method of claim 1, wherein the ith list has a length lᵢ, and k is a fixed percentage of any lᵢ.

8. The method of claim 5, wherein said fixed percentage is from about 1% to about 5% and k is rounded to a nearest integer value.

9. The method of claim 1, wherein n=2.

10. The method of claim 1, wherein n=3 or more.

11. A method of determining whether a test sample, having test data T, is categorized in a first class or a second class, comprising:
extracting a plurality of emerging patterns from a training data set D that has at least one instance of a first class of data and at least one instance of a second class of data;
creating a first list and a second list wherein:
said first list contains a frequency of occurrence, ƒᵢ(m), of each emerging pattern EP₁(M) from said plurality of emerging patterns that has a non-zero occurrence in said first class of data; and
said second list contains a frequency of occurrence, ƒ₂(m), of each emerging pattern EP₂(m) from said plurality of emerging patterns that has a non-zero occurrence in said second class of data;
using a fixed number, k, of emerging patterns, wherein k is substantially less than a total number of emerging patterns in the plurality of emerging patterns, calculating:
a first score derived from the frequencies of k emerging patterns in said first list that also occur in said test data, and
a second score derived from the frequencies of k emerging patterns in said second list that also occur in said test data; and
deducing whether the test data is categorized in the first class of data or in the second class of data by selecting the higher of said first score and said second score.

12. The method of claim 11, additionally comprising:
if said first score and said second score are equal, deducing whether the test sample is categorized in the first class of data or in the second class of data by selecting the larger of the first or the second class of data.

13. The method of claim 11, wherein:
said k emerging patterns of said first list that occur in said test data have the highest frequencies of occurrence in said first list amongst all those emerging patterns of said first list that occur in said test data; and
said k emerging patterns of said second list that occur in said test data have the highest frequencies of occurrence in said second list amongst all those emerging patterns of said second list that occur in said test data.

14. The method of claim 11, wherein:
emerging patterns in said first list are ordered in descending order of said frequency of occurrence in said first class of data, and
emerging patterns in said second list are ordered in descending order of said frequency of occurrence in said second class of data.

15. The method of claim 11, additionally comprising:
creating a third list and a fourth list, wherein:
said third list contains a frequency of occurrence, ƒ₁(iₘ), in said first class of data of each emerging pattern iₘ from said plurality of emerging patterns that has a non-zero occurrence in said first class of data and which also occurs in said test data; and
said fourth list contains a frequency of occurrence, ƒ₂(jₘ), in said second class of data of each emerging pattern jₘ from said plurality of emerging patterns that has a non-zero occurrence in said second class of data and which also occurs in said test data; and wherein
emerging patterns in said third list are ordered in descending order of said frequency of occurrence in said first class of data, and
emerging patterns in said fourth list are ordered in descending order of said frequency of occurrence in said second class of data.

16. The method of claim 15, wherein:
said first score is given by:
$${\sum }_{m = 1}^{k} \frac{{f}_{1} ( {i}_{m} )}{{f}_{1} ( m )} {\vert}_{{EP}_{1} ( {i}_{m} ) ∈ T} ; and$$
said second score is given by:
$${\sum }_{m = 1}^{k} \frac{{f}_{2} ( {j}_{m} )}{{f}_{2} ( m )} {\vert}_{{EP}_{2} ( {j}_{m} ) ∈ T} .$$

17. The method of claim 11, wherein said first list has a length l₁, and said second list has a length l₂, and k is a fixed percentage of whichever of l₁ and l₂ is smaller.

18. The method of claim 11, wherein said first list has a length l₁, and said second list has a length. l₂, and k is a fixed percentage of a sum of l₁ and l₂.

19. The method of claim 11, wherein said first list has a length l₁, and said second list has a length l₂, and k is a fixed percentage of any one of l₁ or l₂.

20. The method of claim 17, wherein said fixed percentage is from about 1% to about 5% and k is rounded to a nearest integer value.

21. The method of claim 1, wherein k is from about 5 to about 50.

22. The method of claim 21, wherein k is about 20.

23. The method of claim 1, wherein each emerging pattern is expressed as a conjunction of conditions.

24. The method of claim 1, wherein only left boundary emerging patterns are used.

25. The method of claim 1, wherein only plateau emerging patterns are used.

26. The method of claim 25 wherein only the most specific plateau emerging patterns are used.

27. The method of claim 1, wherein each of said emerging patterns has a growth rate larger than a threshold, □.

28. The method of claim 27 wherein said threshold is from about 2 to about 10.

29. The method of claim 1, wherein each of said emerging patterns has a growth rate of ∞.

30. The method of claim 1, additionally comprising discretizing said data set, before said extracting.

31. The method of claim 30, wherein said discretizing utilizes an entropy-based method.

32. The method of claim 30, additionally comprising applying a method of correlation based feature selection to said data set, after said discretizing.

33. The method of claim 30 additionally comprising applying a chi-squared method to said data set, after said discretizing,

34. The method of claim 1, wherein said data set comprises gene expression data.

35. The method of claim 34, wherein said gene expression data has been acquired from a micro-array apparatus.

36. The method of claim 1, wherein at least one class of data corresponds to data for a first type of cell and at least another class of data corresponds to data for a second type of cell.

37. The method of claim 36, wherein said first type of cell is a normal cell and said second type of cell is a cancerous cell.

38. The method of claim 1, wherein at least one class of data corresponds to data for a first population of subjects and at least another class of data corresponds to data for a second population of subjects.

39. The method of claim 1, wherein said data set comprises patient medical records.

40. The method of claim 1, wherein said data set comprises financial transactions.

41. The method of claim 1, wherein said data set comprises census data.

42. The method of claim 1, wherein said data set comprises characteristics of an item selected from the group consisting of a foodstuff; an article of manufacture; and a raw material.

43. The method of claim 1, wherein said data set comprises environmental data.

44. The method of claim 1, wherein said data set comprises meteorological data.

45. The method of claim 1, wherein said data set comprises characteristics of a population of organisms.

46. The method of claim 1, wherein said data set comprises marketing data.

47. A computer program product for determining whether a test sample, for which there exists test data, is categorized in a first class or a second class, wherein the computer program product is for use in conjunction with a computer system, the computer program product comprising:
a computer readable storage medium and a computer program mechanism embedded therein, the computer program mechanism comprising:
at least one statistical analysis tool;
at least one sorting tool; and
control instructions for:
accessing a data set that has at least one instance of a first class of data and at least one instance of a second class of data;
extracting a plurality of emerging patterns from said data set;
creating a first list and a second list wherein, for each of said plurality of emerging patterns:
said first list contains a frequency of occurrence, ƒᵢ⁽¹⁾, of each emerging pattern i from said plurality of emerging patterns that has a non-zero occurrence in said first class of data, and
said second list contains a frequency of occurrence, ƒᵢ⁽²⁾, of each emerging pattern i from said plurality of emerging patterns that has a non-zero occurrence in said second class of data;
using a fixed number, k, of emerging patterns, wherein k is substantially less than a total number of emerging patterns in the plurality of emerging patterns, calculating:
a first score derived from the frequencies of k emerging patterns in said first list that also occur in said test data, and
a second score derived from the frequencies of k emerging patterns in said second list that also occur in said test data; and
deducing whether the test sample is categorized in the first class of data or in the second class of data by selecting the higher of the first score and the second score.

48. The computer program product of claim 47, additionally comprising instructions for:
if said first score and said second score are equal, deducing whether the test sample is categorized in the first class of data or in the second class of data by selecting the larger of the first or the second class of data.

49. The computer program product of claim 47, wherein:
said k emerging patterns of said first list that occur in said test data have the highest frequencies of occurrence in said first list amongst all those emerging patterns of said first list that occur in said test data; and
said k emerging patterns of said second list that occur in said test data have the highest frequencies of occurrence in said second list amongst all those emerging patterns of said second list that occur in said test data.

50. The computer program product of claim 47, further comprising control instructions for:
ordering emerging patterns in said first list in descending order of said frequency of occurrence in said first class of data, and
ordering emerging patterns in said second list in descending order of said frequency of occurrence in said second class of data.

51. The computer program product of claim 47, additionally comprising instructions for:
creating a third list and a fourth list, wherein:
said third list contains a frequency of occurrence, ƒ₁(iₘ), in said first class of data of each emerging pattern iₘ from said plurality of emerging patterns that has a non-zero occurrence in said first class of data and which also occurs in said test data; and
said fourth list contains a frequency of occurrence, ƒ₂(jₘ), in said second class of data of each emerging pattern jₘ from said plurality of emerging patterns that has a non-zero occurrence in said second class of data and which also occurs in said test data, and wherein
emerging patterns in said third list are ordered in descending order of said frequency of occurrence in said first class of data, and
emerging patterns in said fourth list are ordered in descending order of said frequency of occurrence in said second class of data.

52. The computer program product of claim 51, further comprising instructions for calculating:
said first score according to the formula:
$${\sum }_{m = 1}^{k} \frac{{f}_{1} ( {i}_{m} )}{{f}_{1} ( m )} {\vert}_{{EP}_{1} ( {i}_{m} ) ∈ T} ; and$$
said second score according to the formula:
$${\sum }_{m = 1}^{k} \frac{{f}_{2} ( {j}_{m} )}{{f}_{2} ( m )} {\vert}_{{EP}_{2} ( {j}_{m} ) ∈ T} .$$

53. The computer program product of claim 47, wherein k is from about 5 to about 50.

54. The computer program product of claim 47, wherein only left boundary emerging patterns are used.

55. The computer program product of claim 47, wherein each of said emerging patterns has a growth rate of ∞.

56. The computer program product of claim 47, wherein said data set comprises data selected from the group consisting of: gene expression data, patient medical records, financial transactions, census data, characteristics of an article of manufacture, characteristics of a foodstuff, characteristics of a raw material, meteorological data, environmental data, and characteristics of a population of organisms.

57. A system for determining whether a test sample, for which there exists test data, is categorized in a first class or a second class, the system comprising:
at least one memory, at least one processor and at least one user interface, all of which are connected to one another by at least one bus;
wherein said at least one processor is configured to:
access a data set that has at least one instance of a first class of data and at least one instance of a second class of data;
extract a plurality of emerging patterns from said data set;
create a first list and a second list wherein, for each of said plurality of emerging patterns:
said first list contains a frequency of occurrence, ƒᵢ⁽¹⁾, of each emerging pattern i from said plurality of emerging patterns that has a non-zero occurrence in said first class of data, and
said second list contains a frequency of occurrence, ƒᵢ⁽²⁾, of each emerging pattern i from said plurality of emerging patterns that has a non-zero occurrence in said second class of data;
use a fixed number, k, of emerging patterns, wherein k is substantially less than a total number of emerging patterns in the plurality of emerging patterns, to calculate:
a first score derived from the frequencies of k emerging patterns in said first list that also occur in said test data, and
a second score derived from the frequencies of k emerging patterns in said second list that also occur in said test data; and
deduce whether the test sample is categorized in the first class of data or in the second class of data by selecting the higher of the first score and the second score.

58. The system of claim 57, wherein said processor is additionally configured to:
if said first score and said second score are equal, deduce whether the test sample is categorized in the first class of data or in the second class of data by selecting the larger of the first or the second class of data.

59. The system of claim 57, wherein:
said k emerging patterns of said first list that occur in said test data have the highest frequencies of occurrence in said first list amongst all those emerging patterns of said first list that occur in said test data; and
said k emerging patterns of said second list that occur in said test data have the highest frequencies of occurrence in said second list amongst all those emerging patterns of said second list that occur in said test data.

60. The system of claim 57, wherein said processor is additionally configured to:
order emerging patterns in said first list in descending order of said frequency of occurrence in said first class of data, and
order emerging patterns in said second list in descending order of said frequency of occurrence in said second class of data

61. The system of claim 57, wherein said processor is additionally configured to:
create a third list and a fourth list, wherein:
said third list contains a frequency of occurrence, ƒ₁(iₘ), in said first class of data of each emerging pattern iₘ from said plurality of emerging patterns that has a non-zero occurrence in said first class of data and which also occurs in said test data; and
said fourth list contains a frequency of occurrence, ƒ₂(jₘ), in said second class of data of each emerging pattern jₘ from said plurality of emerging patterns that has a non-zero occurrence in said second class of data and which also occurs in said test data; and wherein
emerging patterns in said third list are ordered in descending order of said frequency of occurrence in said first class of data, and
emerging patterns in said fourth list are ordered in descending order of said frequency of occurrence in said second class of data.

62. The system of claim 61, wherein said processor is additionally configured to calculate:
said first score according to the formula:
$${\sum }_{m = 1}^{k} \frac{{f}_{1} ( {i}_{m} )}{{f}_{1} ( m )} {\vert}_{{EP}_{1} ( {i}_{m} ) ∈ T} ; and$$
said second score according to the formula:
$${\sum }_{m = 1}^{k} \frac{{f}_{2} ( {i}_{m} )}{{f}_{2} ( m )} {\vert}_{{EP}_{2 ( {j}_{m} )} εT} .$$

63. The system of claim 57, wherein k is from about 5 to about 50.

64. The system of claim 57, wherein only left boundary emerging patterns are used.

65. The system of claim 57, wherein each of said emerging patterns has a growth rate of ∞.

66. The system of claim 57, wherein said data set comprises data selected from the group consisting of: gene expression data, patient medical records, financial transactions, census data, characteristics of an article of manufacture, characteristics of a foodstuff, characteristics of a raw material, meteorological data, environmental data, and characteristics of a population of organisms.

67. A method of determining whether a sample cell is cancerous, comprising:
extracting a plurality of emerging patterns from a data set that comprises gene expression data for a plurality of cancerous cells and a gene expression data for a plurality of normal cells;
creating a first list and a second list wherein:
said first list contains a frequency of occurrence, ƒᵢ⁽¹⁾, of each emerging pattern i from said plurality of emerging patterns that has a non-zero occurrence in said cancerous cells, and
said second list contains a frequency of occurrence, ƒᵢ⁽²⁾, of each emerging pattern i from said plurality of emerging patterns that has a non-zero occurrence in said normal cells;
using a fixed number, k, of emerging patterns, wherein k is substantially less than a total number of emerging patterns in the plurality of emerging patterns, calculating:
a first score derived from the frequencies of k emerging patterns in said first list that also occur in said test data, and
a second score derived from the frequencies of k emerging patterns in said second list that also occur in said test data; and
deducing whether the sample cell is cancerous if said first score is higher than said second score.

68. A method of determining whether a test sample, having test data T, is categorized in one of a number of classes, substantially as hereinbefore described with reference to and as illustrated in the accompanying drawings.

69. A computer program product for determining whether a test sample, for which there exists test data, is categorized in a first class or a second class, wherein the computer program product is for use in conjunction with a computer system, the computer program product comprising:
a computer readable storage medium and a computer program mechanism embedded therein, the computer program mechanism comprising:
at least one statistical analysis tool;
at least one sorting tool; and
control instructions for:
accessing a data set that has at least one instance of a first class of data and at least one instance of a second class of data;
extracting a plurality of emerging patterns from said data set;
creating a first list and a second list wherein, for each of said plurality of emerging patterns:
said first list contains a frequency of occurrence, ƒᵢ⁽¹⁾, of each emerging pattern i from said plurality of emerging patterns that has a non-zero occurrence in said first class of data, and
said second list contains a frequency of occurrence, ƒᵢ⁽²⁾, of each emerging pattern i from said plurality of emerging patterns that has a non-zero occurrence in said second class of data;
using a fixed number, k, of emerging patterns, wherein k is substantially less than a total number of emerging patterns in the plurality of emerging patterns, calculating:
a first score derived from the frequencies of k emerging patterns in said first list that also occur in said test data, and
a second score derived from the frequencies of k emerging patterns in said second list that also occur in said test data; and
deducing whether the test sample is categorized in the first class of data or in the second class of data by selecting the higher of the first score and the second score operable according to the method of claim 1.

70. A computer program product operable according to the method of claim 1.

71. A computer program product for determining whether a test sample, for which there exists test data, is categorized in one of a number of classes, constructed and arranged to operate substantially as hereinbefore described with reference to and as illustrated in the accompanying drawings.

72. A system for determining whether a test sample, for which there exists test data, is categorized in a first class or a second class, the system comprising:
at least one memory, at least one processor and at least one user interface, all of which are connected to one another by at least one bus;
wherein said at least one processor is configured to:
access a data set that has at least one instance of a first class of data and at least one instance of a second class of data;
extract a plurality of emerging patterns from said data set;
create a first list and a second list wherein, for each of said plurality of emerging patterns:
said first list contains a frequency of occurrence, ƒᵢ⁽¹⁾, of each emerging pattern i from said plurality of emerging patterns that has a non-zero occurrence in said first class of data, and
said second list contains a frequency of occurrence, ƒᵢ⁽²⁾, of each emerging pattern i from said plurality of emerging patterns that has a non-zero occurrence in said second class of data;
use a fixed number, k, of emerging patterns, wherein k is substantially less than a total number of emerging patterns in the plurality of emerging patterns, to calculate:
a first score derived from the frequencies of k emerging patterns in said first list that also occur in said test data, and
a second score derived from the frequencies of k emerging patterns in said second list that also occur in said test data; and
deduce whether the test sample is categorized in the first class of data or in the second class of data by selecting the higher of the first score and the second score operable according to the method of claim 1.

73. A system for determining whether a test sample, for which there exists test data, is categorized in one of a number of classes, constructed and arranged to operate substantially as hereinbefore described with reference to and as illustrated in the accompanying drawings.

74. A system operable according to the method of claim 1.

75. A system for determining whether a test sample, for which there exists test data, is categorized in a first class or a second class, the system comprising:
at least one memory, at least one processor and at least one user interface, all of which are connected to one another by at least one bus;
wherein said at least one processor is configured to:
access a data set that has at least one instance of a first class of data and at least one instance of a second class of data;
extract a plurality of emerging patterns from said data set;
create a first list and a second list wherein, for each of said plurality of emerging patterns:
said first list contains a frequency of occurrence, ƒᵢ⁽¹⁾, of each emerging pattern i from said plurality of emerging patterns that has a non-zero occurrence in said first class of data, and
said second list contains a frequency of occurrence, ƒᵢ⁽²⁾, of each emerging pattern i from said plurality of emerging patterns that has a non-zero occurrence in said second class of data;
use a fixed number, k, of emerging patterns, wherein k is substantially less than a total number of emerging patterns in the plurality of emerging patterns, to calculate:
a first score derived from the frequencies of k emerging patterns in said first list that also occur in said test data, and
a second score derived from the frequencies of k emerging patterns in said second list that also occur in said test data; and
deduce whether the test sample is categorized in the first class of data or in the second class of data by selecting the higher of the first score and the second score for use with the computer program product of claim 47.
